(19) United States
(12) Patent Application Publication
(10) Pub. No.: US 2026/0043951 A1
(43) Pub. Date: Feb. 12, 2026

(54) SYSTEM CONFIGURED WITH A REFRACTIVE INDEX MODULATION (RIM) DEVICE

(71) Applicant: Blue Laser Fusion, Inc., Palo Alto, CA (US)

(72) Inventors: Srinivas GANDROTHULA, Palo Alto, CA (US); Shuji NAKAMURA, Goleta, CA (US)

(21) Appl. No.: 19/322,459

(22) Filed: Sep. 8, 2025

Related U.S. Application Data
(63) Continuation-in-part of application No. 18/939,089, filed on Nov. 6, 2024, now Pat. No. 12,416,822.
Application No. 18/939,089 is a division of application No. 18/799,148, filed on Aug. 9, 2024, now Pat. No. 12,422,600.

(51) Int. Cl. G02B 5/08; G02B 17/00; H02N 2/00; H02N 2/04

(52) U.S. Cl. CPC G02B 5/0833; G02B 17/004; H02N 2/04; H02N 2/22

(57) ABSTRACT

Refractive index modulation (RIM) underpins desirable photonic functions including phase and intensity control, beam steering, dispersion tuning, and quantum signal routing. Conventional mechanisms face inherent trade-offs: large Δn but slow (thermal, liquid crystal), or fast but limited Δn (electro-optic, acousto-optic). We present a new RIM platform using nanoporous piezoelectric III-nitrides (GaN, AlN, InN, GaAlScN) with sub-wavelength pores. Dynamic pore refilling driven electrically, acoustically, or optically achieves Δneff=0.001-0.3 with sub-nanosecond response, sub-volt drive, and femtofarad capacitance. This enables compact, broadband, integrable devices for ultrafast communications, LiDAR, AR/VR, spectroscopy, adaptive imaging, and quantum photonics, unifying speed, efficiency, and multifunctionality.

### CROSS-REFERENCE TO RELATED APPLICATIONS

This application is a continuation in part of LASER BEAM EXTRACTION USING DISTRIBUTED BRAGG REFLECTOR (DBR) MIRROR SYSTEMS WITH A PIEZOELECTRIC LAYER listed under U.S. Ser. No. 18/939,089 filed Nov. 6, 1924, now issued as U.S. Pat. No. 12,416,822 on Sep. 16, 2025, which is a divisional of LASER BEAM EXTRACTION USING DISTRIBUTED BRAGG REFLECTOR (DBR) MIRROR SYSTEMS WITH A PIEZOELECTRIC LAYER listed under U.S. Ser. No. 18/799,148 filed Aug. 9, 1924, commonly assigned, and hereby incorporated by reference herein.

### BACKGROUND OF INVENTION

The control of the refractive index of an optical medium is a fundamental capability in photonics, underpinning a vast array of functions such as phase modulation [1], intensity modulation [2], polarization control [3], beam steering [4], frequency shifting [5], dispersion management [6], and holographic projection [7]. In practical photonic devices, the ability to modulate refractive index enables precise tailoring of optical path length, phase velocity, and modal confinement. This in turn supports the encoding, routing, and processing of optical signals across diverse domains including classical communication networks, imaging systems, sensing platforms, and quantum photonics. The magnitude of achievable index change (Δn), along with the modulation speed, spatial resolution, and compatibility with integration platforms, collectively determine the ultimate performance limits of these systems.

Over decades of development, multiple physical mechanisms and device architectures have been employed to achieve refractive index modulation (RIM). Electro-optic modulators (EOMs)[8], typically based on the Pockels effect in non-centrosymmetric crystals such as lithium niobate (LiNbO₃), potassium di-deuterium phosphate (KDP), beta-barium borate (BBO), rubidium titanyl phosphate (RTP), or ammonium dihydrogen phosphate (ADP), provide high-speed modulation with half-wave voltages (Vπ) in the hundreds to thousands of volts and interaction lengths of 1-5 cm. Integrated LiNbO₃ waveguides reduce voltage requirements but still achieve only modest Δn values on the order of 10⁻⁴-10⁻³, necessitating millimeter-scale paths. Performance is further constrained by electrode capacitance and the difficulty of matching the velocities of microwave and optical modes.

Acousto-optic modulators (AOMs) [9] operate by launching RF-driven acoustic waves in crystals such as tellurium dioxide (TeO₂), fused silica, or quartz, producing periodic density and refractive index variations through the photoelastic effect. While useful for beam deflection, frequency shifting, and Q-switching, the Δn per acoustic cycle is small (10⁻⁵-10⁻⁴), requiring centimeter-scale optical paths, significant RF power, and careful thermal management. Modulation bandwidth is also limited by acoustic velocity and phase-matching constraints.

Thermo-optic modulators[10], common in silicon, polymers, and silica-on-silicon platforms, rely on resistive heating to exploit the temperature dependence of refractive index (dn/dT). These devices can achieve relatively large Δn values (up to 10⁻²) but suffer from inherently slow responses in the microsecond-to-millisecond range, high static power consumption, and thermal crosstalk that complicates dense integration.

Electro-absorption modulators (EAMs) [11], based on the Franz-Keldysh or quantum-confined Stark effect in materials such as InGaAsP, GaAs, or Ge-on-Si, are compact and fast, but their index modulation capability is limited compared to amplitude modulation, and they incur insertion losses from residual absorption.

Liquid crystal modulators [12] offer very large Δn values (>0.2) and support broad apertures, making them attractive for spatial light modulators and tunable lenses, but their millisecond-scale response times, polarization sensitivity, and limited durability under high optical power constrain high-speed applications.

MEMS-actuated and metasurface-based modulators[13] can reconfigure optical paths with high contrast by mechanically displacing subwavelength elements, yet moving parts restrict speeds to the kilohertz-to-megahertz range and introduce wear and long-term reliability issues.

Plasmonic modulators[14] achieve ultrafast modulation by altering electron density at metal-dielectric interfaces, enabling speeds exceeding hundreds of gigahertz, but they suffer from high ohmic losses, small mode volumes, and integration challenges.

Across these varied approaches, a set of fundamental trade-offs persists. Mechanisms that yield large Δn, such as thermal tuning or liquid crystal reorientation, are inherently slow, while fast mechanisms like the Pockels or acousto-optic effects exhibit small Δn values. Achieving sufficient phase shift with small Δn typically demands large device sizes and high drive voltages, which are incompatible with compact, low-power integrated photonics. High-speed devices frequently incur additional optical loss, whether from intrinsic absorption in electro-absorption modulators or scattering in complex nanostructures. Many materials offering desirable modulation properties, such as LiNbO₃ or TeO₂, are not native to standard silicon, silicon nitride, or III-V photonic platforms, necessitating hybrid assembly that increases cost and complexity. Power dissipation, whether static in thermal devices or dynamic in high-RF-power acousto-optic devices, further limits scalability in dense photonic systems. Additionally, most conventional modulators are optimized for a single function, lacking the adaptability to perform multiple optical control roles within the same device footprint.

These limitations highlight the need for a new refractive index modulation platform that simultaneously offers large Δn, sub-nanosecond response times, compact footprint, low-voltage operation, broadband transparency, and seamless integration with existing photonic manufacturing processes. The present invention and the examples described herein address these needs by exploiting energy-controlled dynamic pore filling in nanoporous piezoelectric materials, enabling device architectures to fulfill multiple photonic functions across classical and quantum domains.

### SUMMARY OF THE INVENTION

The present invention introduces a fundamentally different refractive index modulation mechanism based on nanoporous, piezo electric material systems, for example III-nitride piezoelectric semiconductors including gallium nitride (GaN), aluminum nitride (AlN), Indium Nitride (InN), gallium-aluminum-scandium nitride (GaAlScN), and their alloys fabricated with subwavelength-scale porosity. Pore diameters are much smaller than the operational wavelength, ensuring the composite behaves as an optically homogeneous medium with no scattering.

Crucially, the pores can be dynamically refilled or evacuated with a material of different refractive index, such as air, under the influence of an external electric field, acoustic wave, optical pump, or other energy stimulus. This dynamic pore-filling process, when combined with the preserved electro-optic and piezoelectric responses of the III-nitride skeleton, produces effective index changes (Δn_{eff}) from −0.001 up to 0.3 an order of magnitude higher than conventional electro-optic materials under similar drive conditions.

Here, the effective referactive index of nanoporpous piezoelectric material means the average refractive index of a whole area of nanoporpous piezoelectric material. The effective refractive index change (Δnₑff) refers to the real-time variation in refractive index of the nanoporous piezoelectric material when subjected to an external stimulus. It is defined as the difference between the refractive index of the porous material with and without the applied external energy.

If the refractive index modulation (RIM) layer is embodied between pairs of dielectric Bragg reflector (DBR) mirrors, the device is collectively referred to as a Resonant Cavity Switching (RCS) device.

In an example, the present invention provides a system. The system has a refractive index modulation (RIM) device comprising a nanoporous piezoelectric material having a plurality of voids. In an example, the system has an energy source generating an external stimulus applied to the nanoporous piezoelectric material to change an effective refractive index (CE_{eff}) of the nanoporous piezoelectric-material; and an optical system including the RIM device such that the RIM device is integrated in the optical system.

Such devices or systems can be implemented in several high-speed and precision optical applications, including:

### Optical Communication Systems

### Wavelength-Division Multiplexing (WDM) Routing

Rapidly selects and switches individual wavelength channels from a dense WDM fiber network without requiring optical-to-electrical conversion. The RCS enables nanosecond-scale optical packet switching, offering speeds orders of magnitude faster than typical MEMS-based switches (˜ms response). This allows network operators to dynamically route traffic and avoid electronic bottlenecks.

### Dynamic Channel Reconfiguration

Allocates bandwidth on demand by instantly switching wavelengths in response to data bursts, improving overall network utilization and latency performance.

### Quantum Communication and Quantum Computing

### Photon-Path Routing in Quantum Networks

Directs single-photon streams at specific wavelengths to different quantum processing nodes with nanosecond precision, ensuring minimal decoherence and preserving quantum state integrity.

### Quantum Memory Access

Rapidly matches the resonance of the RCS to quantum memory absorption lines, enabling high-speed read/write access to quantum storage devices without mechanical tuning delays.

### Ultrafast Spectroscopy and Pump-Probe Experiments

### Wavelength-Selective Excitation

Excites a sample at one wavelength and switches to a second wavelength within nanoseconds, enabling transient state interrogation before relaxation processes occur.

### Time-Resolved Measurements

Performs selective spectral probing of molecular or material dynamics on the nanosecond scale, allowing mapping of ultrafast processes such as carrier recombination, phase transitions, or chemical reactions.

### Lidar and Remote Sensing

### Multi-Wavelength Pulsed Lidar

Alternates probe wavelengths between pulses for differential absorption lidar (DIAL), enabling atmospheric composition sensing and pollutant detection in real time.

### Spectral Target Discrimination

Switches probing wavelengths rapidly to differentiate between materials, coatings, or gases based on their spectral fingerprints, improving accuracy in real-time mapping and identification.

### High-Speed Optical Signal Processing

### All-Optical Logic and Computing

Enables nanosecond-level wavelength gating for implementing optical logic gates, wavelength-based routing, and switching in photonic processors without resorting to electronic conversion.

### Optical Correlation/Pattern Recognition

Dynamically filters for specific wavelength signatures, enabling high-speed data sorting, encryption, or spectral image processing in defense, biomedical, or industrial inspection systems.

### Laser Source Multiplexing

Pulse Picking from Multiple Lasers

Combines outputs from multiple lasers at different wavelengths into a single beam path, with channel switching in under 10 ns for precision multi-wavelength experiments or surgical applications.

### Fast Tunable Laser Output

Integrates into a laser cavity to provide rapid wavelength tuning for scanning-based applications such as spectroscopy, hyperspectral imaging, or frequency-comb shaping.

### Military/Aerospace Applications

### Countermeasure Systems

Rapidly switches laser wavelengths to disrupt or evade optical seekers and tracking systems tuned to fixed spectral bands.

### Adaptive Multi-Spectral Imaging

Dynamically filters to the most effective spectral band for target recognition, navigation, or threat detection under changing environmental or lighting conditions.

### Technical Advantage of RCS Over Other Tunable Filters:

Unlike acousto-optic tunable filters (AOTFs), electro-optic tunable filters (EOTFs), or MEMS-based wavelength selectors, the RCS leverages ultrafast refractive index modulation in a high-finesse cavity, enabling sub-nanosecond wavelength switching, high extinction ratio, and minimal insertion loss. This makes it ideal for real-time systems where both speed and spectral precision are critical.

### Refractive Index Modulation (RIM) Devices—Standalone Integration Across Multiple Applications

The present invention offers a number of key advantages that enable improvements in the design and performance of integrated photonic systems.

One of the primary benefits is the dramatic reduction in device footprint. Unlike traditional bulk Pockels crystals, which require phase shift lengths ranging from 10 to 50 millimeters, the described approach achieves equivalent 71 phase shifts within ultra-compact lengths of just 2 to 80 micrometers. This substantial miniaturization enables far more compact photonic components and systems, facilitating integration at scales previously unattainable.

In addition to size reduction, the invention enables low-voltage, low-energy operation. Due to the strong overlap between the optical mode and the applied electric field—combined with device capacitance in the femtofarad range—sub-volt driving voltages are feasible. This results in drastically reduced power consumption, a advantage for high-speed optical interconnects and other energy-sensitive applications.

The device architecture also supports high modulation depth at high frequencies. Effective refractive index changes (Δnₑff) of up to 0.3 can be achieved, with modulation bandwidths exceeding 50 to 80 GHz. These characteristics make the invention suitable for both large-signal optical switching and ultrafast small-signal phase control, accommodating a wide range of modulation formats and speeds.

Material choice further enhances the versatility of the invention. By utilizing wide bandgap III-nitride semiconductors, which are transparent from the ultraviolet through the infrared spectrum, the platform supports broad spectral compatibility. This allows for multi-wavelength operation within a single integrated device, offering significant utility in wavelength-division multiplexed systems and other broadband applications.

Moreover, the invention enables monolithic integration. The active layers can be grown and fabricated directly on a variety of substrates, including silicon, sapphire, and native III-nitride wafers. This compatibility with standard photonic integrated circuit (PIC) manufacturing processes simplifies fabrication and promotes scalability.

Finally, the invention supports multifunctional operation. A single refractive index modulation (RIM) layer can perform multiple optical functions, including phase modulation, amplitude modulation, polarization rotation, beam steering, frequency shifting, dispersion tuning, and enhancement of nonlinear optical effects. This multifunctionality reduces component count, simplifies system design, and enables highly integrated and reconfigurable photonic platforms.

By overcoming the historic trade-off between modulation magnitude and speed, RIM devices offer a unified, high-performance index modulation technology applicable across coherent communications, LiDAR, AR/VR, quantum photonics, ultrafast optics, and adaptive imaging—as detailed in the following application categories.

The described technology lends itself to a broad range of applications across optical communications, sensing, imaging, quantum photonics, and advanced display systems, among others. Its unique combination of compact size, low-voltage operation, high-speed modulation, and material compatibility enables transformative improvements in both performance and integration.

### Optical Communications

The invention can significantly enhance next-generation optical communication systems. In Mach-Zehnder Modulators (MZMs), the ability to reduce modulator lengths from centimeters to tens of micrometers, combined with sub-1 V drive capability, facilitates energy-efficient data transmission, particularly beneficial in high-throughput environments such as data centers and long-haul telecommunications networks. Similarly, in microring resonator modulators, the technology enables a greater wavelength tuning range per volt, allowing for fast and efficient switching across dense wavelength-division multiplexing (DWDM) channels with minimal power consumption. The invention also supports reconfigurable optical switches capable of true sub-nanosecond switching speeds, offering a compelling alternative to slower thermo-optic or MEMS-based devices in fiber-optic networks.

### LiDAR and Beam Steering

For LiDAR systems and beam steering applications, the invention enables compact, solid-state implementations with no moving parts. In optical phased arrays (OPAs), it allows wide-angle beam steering using fewer phase shifters, enhancing scalability and reducing power requirements—ideal for automotive and robotics applications. In addition, the technology supports variable-focus lenses through thin-film tunable structures, allowing dynamic control of focal length in real-time. These tunable lenses are well suited for integration into LiDAR scanners and augmented or virtual reality (AR/VR) headsets.

### Laser Systems

In laser-based systems, the invention provides a compact and efficient platform for several functions. High-speed Q-switches can be realized with sub-millimeter device lengths and reduced voltage requirements, enabling nanosecond pulse gating in compact, high-repetition-rate laser systems. The technology also supports tunable laser cavities, offering rapid and broadband wavelength tuning for applications such as swept-source optical coherence tomography (OCT). Moreover, the invention can be used to fabricate compact, electrically driven mode-locking elements, allowing for the generation of ultrafast pulses in integrated laser systems.

### Sensing and Imaging

The invention enables advanced optical sensing and imaging functionalities. In hyperspectral cameras, it can serve as a fast-switching, tunable narrowband filter for real-time material and chemical identification. Adaptive optics systems benefit from real-time wavefront correction to compensate for atmospheric or system-induced distortions, improving image fidelity in telescopes, microscopes, and free-space optical communication links. Additionally, the technology facilitates compact, integrated interferometers, enabling precise on-chip phase control in metrology and sensing platforms.

### Quantum Photonics

The compactness, speed, and index tunability of the invention make it well suited for quantum photonics. It supports the realization of on-chip quantum gates for high-fidelity switching and routing of single photons. Dynamic delay lines can be implemented by modulating the refractive index to control photon arrival times, a function for quantum memory and synchronization. Furthermore, the ability to induce strong index changes enhances nonlinear photon interactions, enabling cross-phase modulation and all-optical logic operations in quantum circuits.

### Displays and Holography

In the field of advanced display systems, the invention enables dynamic holographic projection, allowing for real-time updates of holographic content at video refresh rates. It also enhances AR/VR waveguide displays through the implementation of strongly tunable couplers, which can inject virtual images into the user's field of view without the need for bulky optics. These features support lightweight, immersive, and high-resolution wearable displays.

### Advanced Optical Components

The invention supports the design of miniaturized lenses and optical elements by leveraging high-index materials to achieve thinner, lighter optics without sacrificing performance. It also allows for tunable lenses and filters with real-time control over focal length and spectral response, enabling adaptive imaging and dynamic spectral filtering. In addition, the platform enables reconfigurable metasurfaces that can perform beam steering, wavefront shaping, polarization control, optical encryption, and ultrafast switching-all without mechanical motion. The technology also offers potential for photonic memory via reversible refractive index changes, providing a mechanism for non-volatile optical data storage.

### Biosensing and Environmental Monitoring

The invention offers significant advantages in biological and environmental sensing. It enables high-sensitivity biosensors capable of detecting minute refractive index changes associated with molecular binding events, facilitating early disease detection. In microscopy, it supports adaptive imaging by correcting aberrations in real time for sharper, higher-contrast images. Furthermore, it can be used to construct ultra-compact spectrometers, suitable for portable chemical and environmental analysis in field applications.

### Communication and Information Processing

In advanced communication and computing systems, the invention enables high-speed optical communication with greater energy efficiency and bandwidth. It also supports optical computing through the development of ultrafast, low-power, all-optical logic and signal processing elements. Within the realm of quantum information processing, the technology facilitates precise control and manipulation of quantum states in photonic integrated circuits, offering pathways toward scalable quantum computing.

### Emerging and Future Applications

Beyond established domains, the invention opens up opportunities for dynamic coloration and smart displays, where tunable optical properties allow for adaptive camouflage, responsive architectural elements, and variable-color panels. It also enhances energy harvesting by improving light management in solar cells and photodetectors, ultimately contributing to higher conversion efficiencies.

In an example, the choice of III-nitride materials, particularly GaN and its alloys with Al, Sc, or In, stems from their desirable combination of wide bandgap (e.g., up to ˜6.2 eV for AlN), high chemical and thermal stability, and strong piezoelectric and spontaneous polarization characteristics. Among these, GaAlScN has recently emerged as a particularly promising candidate due to its enhanced piezoelectric coefficients and tunable mechanical properties resulting from scandium substitution in the wurtzite lattice. For example, at ˜40% Sc incorporation, GaAlScN exhibits a piezoelectric constant e31 approximately −80 C/m², 50 times higher than that of pure AlN (−1.6 C/m²). These enhanced piezoelectric properties are for enabling effective refractive index modulation in response to strain fields generated by surface acoustic waves (SAWs) or applied electrical signals. Additionally, GaAlScN offers superior acoustic impedance matching, providing finer control over modulation speed and bandwidth.

In an example, an initial step in creating the nanoporous structure involves deposition of a Si-doped III-nitride layer, typically 100-500 nm thick. This layer is grown using methods tailored for the target application and fabrication scale. Metal-organic chemical vapor deposition (MOCVD) enables the growth of high-quality epitaxial films with precise control over alloy composition and thickness, making it well suited for applications requiring high optical performance. Sputtering techniques, including DC and RF plasma-enhanced (PE) physical vapor deposition (PVD), are also widely used and are capable of depositing GaAlScN films on larger substrates (e.g., 4-6 inch wafers) with growth rates around 200 nm/hr. Ion beam deposition (IBD) and electron cyclotron resonance (ECR) plasma tools are often used to deposit ultrathin dielectric or conductive layers such as ITO, Si₃N₄, or Al₂O₃, which serve as surface passivation or etch masks. Prior to electrochemical porosification, the doped layer is typically capped with a thin undoped III-nitride layer (1-50 nm), plasma-enhanced chemical vapor deposition PECVD-grown SiO₂, or a conductive ITO film to protect the surface and improve pore uniformity. Here, we call DC, RF sputtering, IBD, ECR and PVD as PVD.

In an example, porosity is introduced through electrochemical etching, wherein the sample is immersed in a dilute acidic electrolyte such as 0.3-0.5 M oxalic acid, nitric acid or hydrochloric acid. A bias voltage of 1-20 V is applied across the sample with a platinum counter electrode, while current densities are maintained between 2-10 mA/cm². Under these conditions, anodic dissolution proceeds preferentially along dislocation sites and grain boundaries, leading to the formation of vertically aligned nanopores. To suppress Rayleigh scattering and ensure low optical loss at wavelengths of 1040-1080 nm, the pore diameter is controlled in the range of 5-30 nm, with inter-pore spacing below 50 nm. Alternatively, the voids or pores can be fabricated with or without chemical etching to make the size of the voids and pores the same. RCS device is used for a light with a wavelength range of, e.g., 300 nm to 3000 nm. The pore diameter is controlled depending on the wavelength of the light.

Alternatively, FIG. 1A illustrates a schematic of an optimized porous layer production process for the device applications described in this disclosure. The layer can be integrated onto Si, sapphire, or photonic integrated circuits for use as a refractive index modulation (RIM) layer, or inserted between two dielectric DBR mirrors for use in a resonant-cavity switching (RCS) device.

In an example, an undoped GaN seed layer is deposited, followed by a Si-assisted sputtered GaN layer, and subsequently capped with another undoped GaN sputtered layer. A dielectric cap layer, typically an oxide material, is then deposited to protect the surface. Porous layers can also be formed through various modifications to this layer stack.

The deposited layer is treated in a controlled chamber under elevated temperature and specific gas environments to produce uniform pores. In an example, Si co-sputtering during deposition was varied to control pore size. As illustrated in FIG. 1B, increasing the Si sputtering rate (from left to right) results in larger pores and greater non-uniformity, whereas a lower Si sputtering rate produces smaller, more uniform pores on the order of 20-30 nm after annealing at 1000° C. It is not yet clear whether Si is incorporated into GaN through co-sputtering, as the Si concentration in GaN has not been measured. The conductivity of GaN films, with or without Si co-sputtering, remained semi-insulating. However, the deposited layer exhibited a decrease in refractive index from 2.1 to 1.96 after annealing, indicating that pores generated during the recrystallization process lowered the refractive index due to the formation of an air-filled void matrix. Effective refractive index values were determined using ellipsometry. A dielectric cap layer was desirable for maintaining high surface quality and achieving low surface roughness.

FIG. 1C shows AFM scans of deposited layers before and after annealing. In capped layers with SiO₂ (left and right images), surface roughness remains below 2 nm, whereas in uncapped layers it increases from sub-2 nm to approximately 35 nm after annealing. Cap layer materials such as SiO₂ or other materials can be used to optimize surface quality.

Porosity in the piezoelectric layer can also be achieved through controlled annealing conditions. After deposition, the layer is subjected to a controlled environment where the temperature is raised in the presence of gases such as N₂, O₂, mixtures of N₂ and O₂, or forming gas. Preferably, annealing under N₂ at 1000° C. produces nanoscale pores, as shown in FIG. 1B. In the range of annealing temperature of 600 C˜1000 C, the porosity in the piezoelectric layer was pretty good. At the temperature of 500 C, the porosity was not good. The as-deposited layer by sputtering exhibits no visible porosity; however, after annealing, nanoscale pores (typically ≤100 nm) are uniformly distributed throughout the layer. This process is compatible with large-scale manufacturing.

In another example, annealing-induced pore formation was demonstrated in a sputter-deposited AlN layer. FIG. 1D shows SEM images of the cross-section of the sputter-deposited AlN film. As deposited, the film exhibited no visible pores, though a columnar structure was identified. However, upon annealing at elevated temperatures in a nitrogen environment, pore formation was initiated. More prominent and uniformly distributed pores with sizes below 50 nm were observed throughout the layer after annealing at 1000° C. for 40 minutes. Correspondingly, the refractive index decreased from 1.87 in the as-deposited layer to 1.72 in the annealed layer, as measured by ellipsometry, confirming that a pore matrix had been embedded within the AlN layer.

Further optimization may enable uniform pore formation across the entire film thickness. In another approach, a multilayer configuration may be employed, in which two differently conditioned layers are sequentially deposited: one layer is selectively porosified while the other serves as a protective or capping layer, thereby preserving high surface quality.

The porosification process is driven by recrystallization dynamics in the presence of reactive or inert gases, which may also act as mild etching agents. Piezoelectric films deposited by methods such as chemical vapor deposition (CVD), plasma-enhanced CVD (PECVD), or sputtering often in a polycrystalline or amorphous state can undergo microstructural rearrangement under annealing, resulting in the formation of nanoscopic pores within the film.

Among these deposition methods, sputtering systems are particularly advantageous for enabling controlled porosification. Sputter deposition inherently produces films with columnar microstructures and variable packing densities, which act as favorable precursors for subsequent pore generation. The process offers fine control over parameters such as gas composition, chamber pressure, substrate temperature, and bias power, all of which influence grain boundary density and defect incorporation. These microstructural features provide diffusion pathways during annealing, thereby enhancing recrystallization-driven void formation. In addition, sputtering is highly scalable, compatible with large-area substrates, and easily integrated into existing semiconductor fabrication lines, making it an ideal approach for producing nanoporous piezoelectric films with tunable refractive index properties.

### BRIEF DESCRIPTION OF THE DRAWINGS

As shown are simplified diagrams or illustrations in the following figures.

FIG. 1A. Schematic of porous III-nitride layer structure.

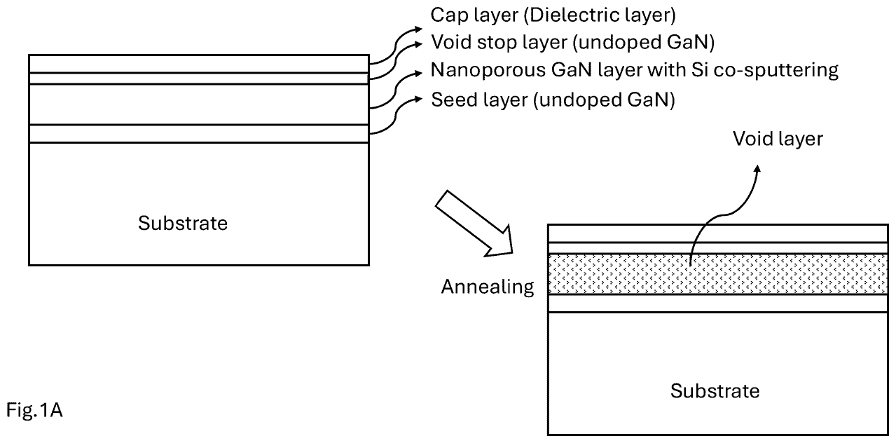

Illustrates the deposition, doping, and capping layers followed by thermal porosification, resulting in uniformly distributed sub-wavelength pores suitable for refractive index modulation.

FIG. 1B. Controlled pore formation via doping and annealing.

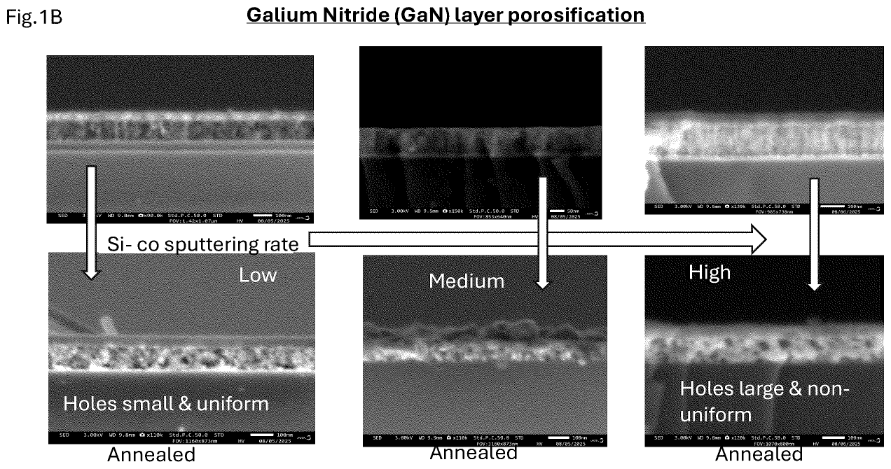

Shows how varying Si sputtering rate and annealing conditions influences pore size and uniformity, enabling engineered refractive index baselines.

FIG. 1C. Surface morphology of capped vs. uncapped porous layers.

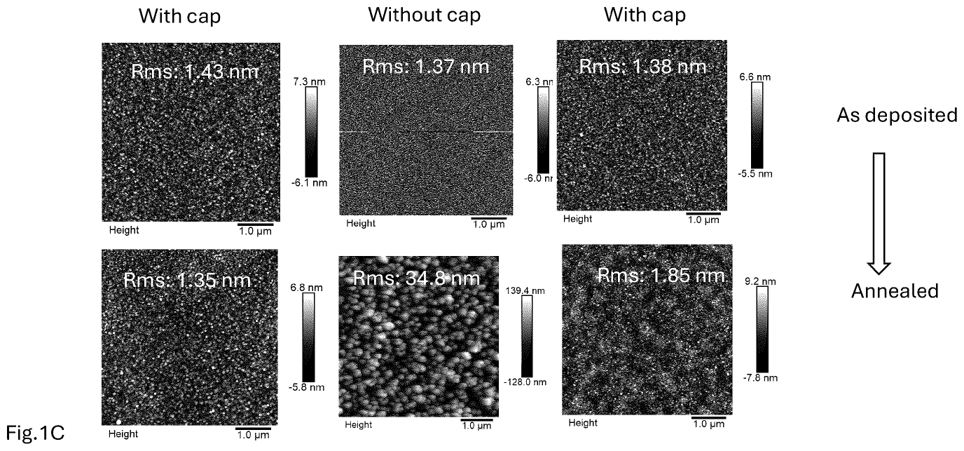

AFM scans compare surface roughness before and after annealing, highlighting the role of dielectric caps in maintaining optical smoothness quality (<2 nm RMS).

FIG. 1D. Controlled pore formation in AlN via annealing.

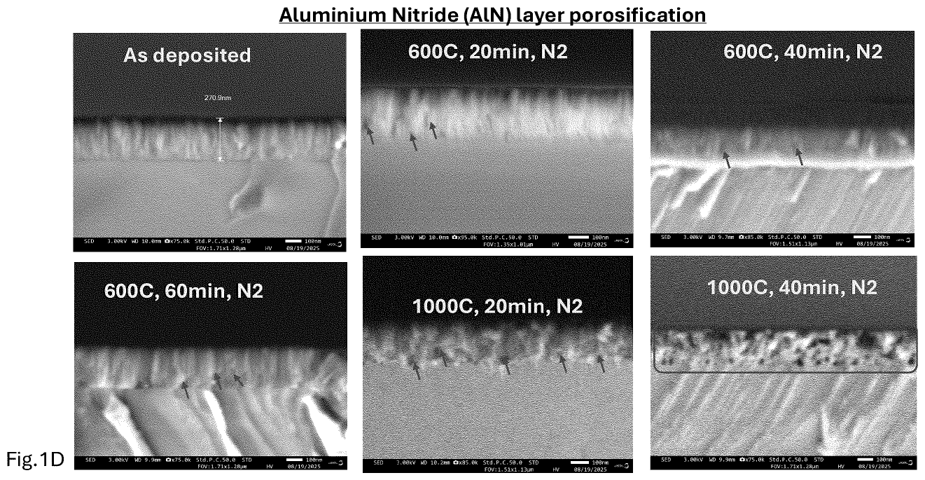

Shows how varying annealing conditions induces pores in the sputter deposited AlN layer.

FIG. 2A. Electro-optic modulator using nanoporous film.

Depicts a compact waveguide phase shifter exploiting Pockels effect, piezoelectric strain, and dynamic pore refilling for Δ_{neff} up to 0.3.

FIGS. 2B/2C. Device electrode configurations.

Configurations show lateral and transparent electrode layouts for driving nanoporous EOM devices while ensuring optical access.

FIG. 3. Mach-Zehnder interferometer with porous RIM arms.

Demonstrates intensity modulation using differential phase shifts induced by nanoporous pore-refilling segments integrated in one or both interferometer arms.

FIG. 4. Nanoporous birefringent modulator for polarization control.

Shows birefringence tuning via anisotropic pore refilling, enabling GHz-speed waveplate operation for polarization multiplexing and scrambling.

FIG. 5. Nanoporous acoustic frequency shifter.

Illustrates traveling acoustic waves modulating pore volumes to create dynamic gratings for efficient GHz-range Doppler frequency shifts.

FIG. 6. Nanoporous optical gate for pulse picking.

Replaces bulk Pockels cells with thin-film nanoporous devices, enabling sub-nanosecond selection of individual pulses in mode-locked lasers.

FIG. 7. Nanoporous tunable lens and phased array.

Shows thin-film metasurface or phased array configuration where local pore refilling modulates phase, enabling real-time beam steering and focal tuning.

FIG. 8. Nanoporous tunable filter and wavelength selector.

Demonstrates ring resonator and Bragg grating implementations with dynamic resonance tuning over tens of nanometers in sub-nanosecond timescales.

FIG. 9. Magnet-free optical isolator using temporal index modulation.

Depicts a nanoporous traveling-wave device achieving nonreciprocity by phase-matching forward light while suppressing backward propagation.

FIG. 10. Dynamic nanoporous photonic crystals.

Shows lithographically patterned nanoporous regions whose refractive index contrast is rapidly tunable, enabling reconfigurable photonic bandgaps.

FIG. 11. Segmented nanoporous dispersion and chirp controller.

Illustrates independently addressable waveguide sections that tailor group delay and dispersion through local pore refilling, enabling per-pulse chirp control.

FIG. 12. Nanoporous tunable filter for hyperspectral imaging.

Depicts Fabry-Perot and grating filter architectures with nanoporous layers for ultrafast wavelength selection across 400-2000 nm.

FIG. 13. Quantum photonic circuit with nanoporous EOMs.

Shows integration of nanoporous RIM phase shifters into interferometers for compact, low-loss, GHz-speed quantum gates.

FIG. 14. Nanoporous dynamic optical delay line.

Spiral waveguide with dynamic pore refilling to modulate group index (ng), enabling broadband, low-noise tunable delays for synchronization and buffering.

FIG. 15. Nanoporous holographic spatial light modulator.

Pixelated nanoporous film where each pixel tunes refractive index independently, providing >2π phase modulation for real-time holography.

FIG. 16. Nanoporous tunable grating coupler for AR/VR waveguides.

Depicts waveguide input with nanoporous subwavelength grating; dynamic pore refilling modulates coupling efficiency for ultrafast brightness control.

### DETAILED DESCRIPTION OF THE DRAWINGS

Electro-optic modulators (EOMs) are devices used to control the phase, intensity, or polarization of light via an externally applied electrical signal. Conventional EOMs operate on the basis of the linear electro-optic (Pockels) effect, wherein the refractive index of a nonlinear crystal is modified in direct proportion to the applied electric field. Typical bulk-type devices utilize Pockels cells made from inorganic crystals such as potassium di-deuterium phosphate (KDP), potassium titanyl phosphate (KTP), beta-barium borate (BBO), lithium niobate (LiNbO₃), lithium tantalate (LiTaO₃), or ammonium dihydrogen phosphate (ADP). In these devices, the half-wave voltage required to achieve a 71 phase shift is often hundreds to thousands of volts, and the resulting change in effective refractive index is typically below 0.001. This low modulation depth necessitates device lengths on the order of millimeters to centimeters, which increases capacitance, limits modulation bandwidth, and raises the electrical drive power requirement. Even in integrated waveguide-based designs, where electrode spacing is reduced to achieve lower Vπ, the modulation efficiency remains constrained by the small achievable Δn_{eff}, and there is no practical route to ultra-large index changes within the same platform.

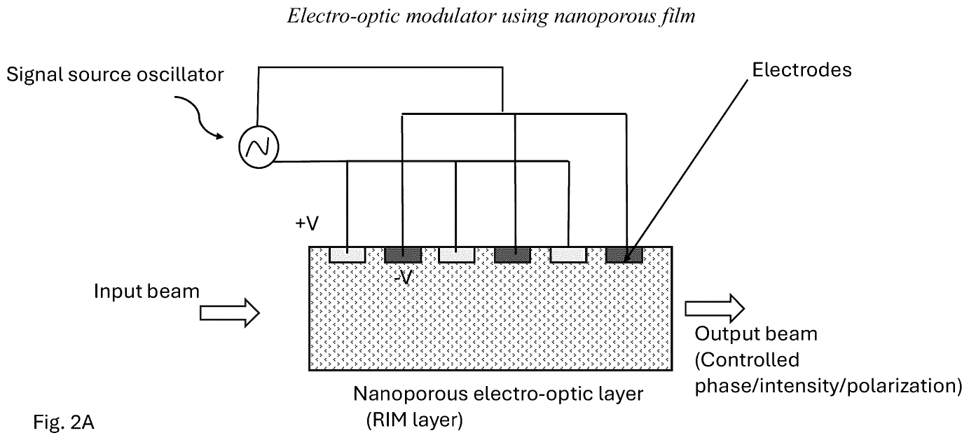

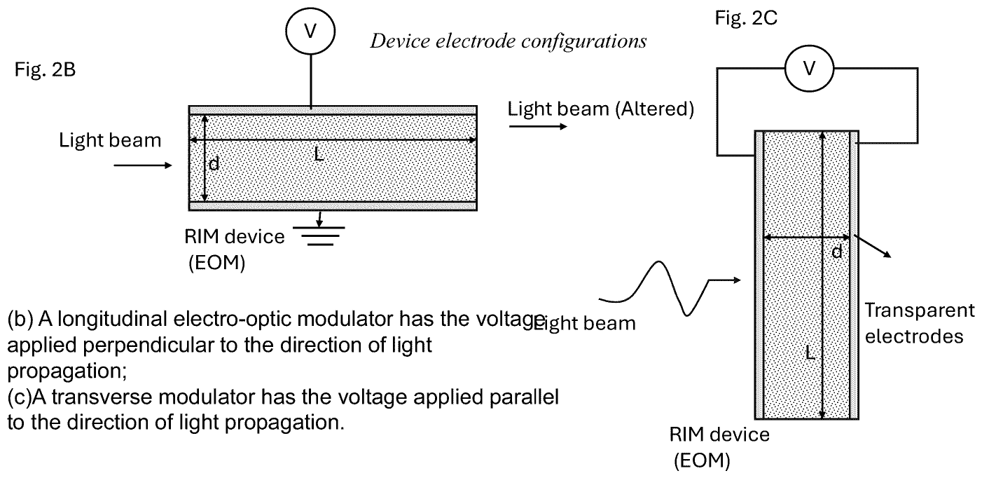

In the present example as shown in FIG. 2(a), a fundamentally different electro-optic modulator architecture is provided, employing a nanoporous piezoelectric material, such as gallium nitride (GaN), aluminum nitride (AlN), Indium nitride (InN), gallium-aluminum-scandium nitride (GaAlScN), or their alloys. The electro-optic layer is engineered with pore diameters smaller than the operational optical wavelength, ensuring that the structure behaves as a homogeneous effective medium with negligible optical scattering. The dense crystalline regions of the III-nitride matrix have a bulk refractive index of approximately 2.4 (for example GaN), while the pores initially contain air or vacuum with a refractive index of approximately 1.0. Porosity is selected to yield a desired baseline effective refractive index, for example, approximately 1.966 at 30% void fraction.

The nanoporous electro-optic layer is integrated within an optical waveguide so that the guided optical mode overlaps substantially with the active modulation region. Electrodes are patterned in either a traveling-wave or lumped-element configuration to apply a modulating electric field across the layer. Because the wurtzite crystal structure of the III-nitride is preserved despite the porosity, the material retains its intrinsic Pockels effect. Furthermore, the sub-wavelength porosity allows for tailored effective dielectric properties and enables additional modulation mechanisms that are not available in dense-crystal EOMs.

When an energy is applied, the device exploits three synergistic effects to achieve a tunable refractive index change: (1) the intrinsic Pockels effect within the crystalline phase; (2) piezoelectric strain in the III-nitride lattice, which mechanically deforms pore boundaries and modifies the effective optical path; and (3) stimulus-induced pore refilling, wherein the voids are partially or fully infiltrated by a higher-index medium through electric-field-assisted condensation, capillary action, or dielectric infiltration. The resulting change in the local optical density of the pore volume produces a macroscopic effective refractive index shift that is additive to the electro-optic and piezoelectric contributions.

This architecture enables a continuous tuning of Δn_{eff} from approximately 0.001, in a Pockels-dominated regime suitable for low-voltage, compact phase modulation, up to approximately 0.3 in a pore-refilling-enhanced regime. At Δn_{eff}≈0.005, the device can achieve a full π phase shift in under 500 μm of optical path length, with reduced capacitance and VπL below 1 V cm, supporting modulation bandwidths above 50 GHz. At Δn_{eff}≈0.3, the required π phase length is reduced to less than 3 μm, yielding sub-femtofarad capacitances, VπL values below 0.05 V·cm, and modulation bandwidths exceeding 100 GHz. Such large index changes are beyond the capability of conventional electro-optic modulators and enable phase shifting, switching, and beam steering functions in footprints orders of magnitude smaller than current state-of-the-art devices.

In one variation, the nanoporous electro-optic layer is optimized to concentrate electric fields around pore perimeters, enhancing the local field in the crystalline regions and amplifying the modulation efficiency. In another, the electrode geometry is configured as a slot waveguide or vertically confined capacitor to further boost the applied field within the optical mode. The device may be fabricated monolithically on silicon, sapphire, or native III-nitride substrates, and is fully compatible with photonic integrated circuit manufacturing. This combination of engineered nanoporous piezoelectric III-nitride materials with intrinsic electro-optic activity, enhanced piezoelectric strain response, and dynamic pore refilling yields a new class of phase shifters with performance metrics, particularly in achievable Δn_{eff}, that are unattainable with traditional Pockels cell or integrated LiNbO₃ modulators

In one implementation, as shown in FIG. 2(b), electrodes are deposited on either side of the nanoporous electro-optic layer, allowing light to pass through the nanoporous face. In another arrangement, shown in FIG. 2(c), the light-facing electrodes are transparent conducting electrodes, enabling the light to be altered while passing through the nanoporous electro-optic layer.

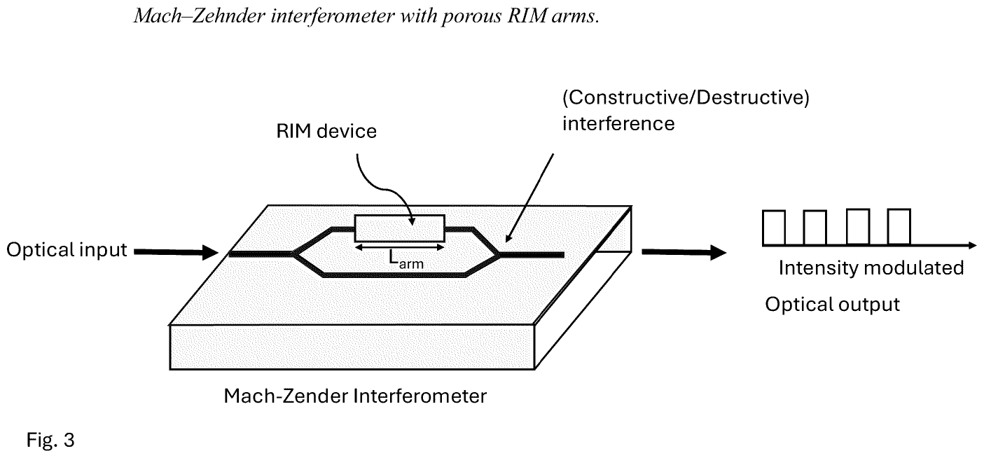

In an example, an optical intensity modulator is realized using a Mach-Zehnder interferometer (MZI) in which the arms contain, in whole or in part, a nanoporous piezoelectric material, for example III-nitride electro-optic layer (e.g., GaN, AlN, InN, GaAlScN) integrated as the optical waveguide core as shown in FIG. 3, or cladding. The nanoporous layer is fabricated with sub-wavelength pores ensuring the optical mode experiences a homogeneous effective medium free from scattering. Electrodes are patterned adjacent to one or both interferometer arms such that an applied bias induces dynamic pore refilling, changing the effective refractive index n_{eff} of the modulated arm(s).

The index change Δn_{eff} arises from two cooperative mechanisms:

Electro-optic modulation in the crystalline skeleton via the Pockels effect, preserving the non-centrosymmetric wurtzite symmetry of the III-nitride host.

Effective-medium tuning from partial pore refilling, wherein the fill fraction, f and/or pore index n_{void} change dynamically under the influence of the electric field, acoustic field, or other energy input.

The induced phase shift in one arm of the interferometer can be expressed as:

$$Δϕ = \frac{2 π}{λ} Δ {n}_{eff} {L}_{arm}$$

where Lₐᵣₘ is the modulated section length and λ is the optical wavelength in vacuum. A relative phase shift of π between the two arms yields complete destructive interference at one output port, corresponding to maximum extinction.

In a small-signal operating regime, where Δn_{eff}≈0.005, full extinction at telecom wavelengths λ≈1.55 μm can be achieved with Larm<0.5 mm. This enables modulators with sub-volt Vπ·L products and modulation bandwidths exceeding 50 GHz due to the reduced electrode capacitance and short active length.

In a large-signal regime, where pore refilling yields Δn_{eff}≥0.1, the same extinction can be achieved with active sections as short as 50 μm. Such compactness dramatically lowers the device capacitance often into the femtofarad range allowing ultra-low-energy operation (tens of femtojoules per bit) and near-RC-free response up to and beyond 100 GHz, depending on electrode and driver design.

Because the modulation is phase-based within the arms and does not rely on absorption, the insertion loss remains significantly lower than in electro-absorption modulators. Moreover, the wide-bandgap III-nitride host material supports high optical power handling, extending the device utility from conventional telecom systems into coherent LiDAR, optical computing, and quantum communication applications.

By varying the fraction of each arm covered with the porous modulator section, fine control over extinction ratio, chirp parameter, and bias point stability can be obtained. The device can be fabricated monolithically on III-nitride-on-silicon or III-nitride-on-sapphire platforms or photonic integrated circuits, allowing dense integration with lasers, detectors, and other photonic elements. This combination of large tunable Δn_{eff}, low loss, and scalability offers a superior alternative to both lithium niobate MZIs and semiconductor electro-absorption modulators in terms of footprint, drive voltage, and operational bandwidth

Conventional polarization control devices such as liquid crystal variable retarders, rotating crystalline waveplates, and integrated LiNbO₃ birefringent modulators face limitations when used in modern high-speed photonic systems. Liquid crystal retarders are inherently slow, with millisecond-scale response times, and cannot meet the sub-nanosecond requirements of high-bit-rate coherent systems. Mechanically rotated waveplates are bulky and have mechanical inertia that prohibits rapid modulation. Even high-speed integrated LiNbO₃ devices are limited in birefringence tuning, requiring millimeter-scale lengths to achieve quarter-wave or half-wave operation, which results in high capacitance, large drive voltages, and limited integration density. These limitations restrict performance in applications such as polarization multiplexing, polarization scrambling, and quantum state preparation.

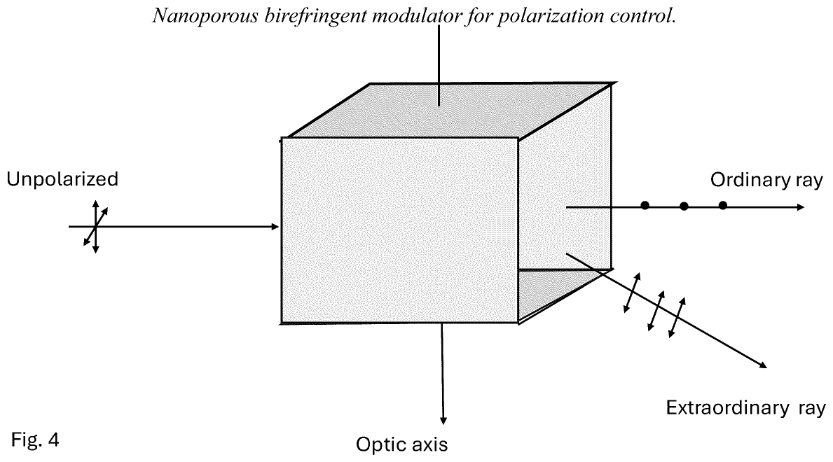

The present invention as illustrated in FIG. 4, birefringent RIM modulator, overcomes these limitations through a nanoporous piezoelectric material, such as III-nitride electro-optic film engineered for anisotropic refractive index modulation via dynamic pore refilling. The wurtzite crystalline orientation is selected such that the ordinary (nₒ) and extraordinary (nₑ) indices respond differently to externally applied energy stimuli. This energy can be supplied as an electric field, acoustic field, optical field, or external energy, each capable of triggering a change in the pore fill fraction f or the refractive index of the voids (n_{void}). Because the pores are substantially smaller than the optical wavelength, the optical mode experiences a homogeneous medium while benefiting from rapid and reversible changes in effective birefringence.

The induced birefringence change is:

$$Δ {n}_{brief} = [ {n}_{e} ( f , {n}_{viod} ) - {n}_{o} ( f , {n}_{void} ) ] - [ {n}_{o}^{0} - {n}_{e}^{0} ]$$

and the retardance is:

$$Γ = \frac{2 π}{λ} Δ {n}_{brief} L$$

With Δn_{biref}≈0.005, quarter-wave operation (Γ=π/2) at λ=1.55 m requires L≈77.5 μm. With Δn_{biref}≥0.1 from large-signal pore refilling, quarter-wave operation is achievable in L≤3.9 m and half-wave in L≤7.8 m. These short lengths reduce device capacitance to the femtofarad range, enabling modulation bandwidths exceeding 50-80 GHz and actuation with sub-nanojoule energy inputs.

In an example, application Relevance and Necessity of the Invention when integrated this RIM into devices are as follows:

### Polarization Multiplexing for Coherent Optical Links

In coherent optical communication systems, orthogonal polarization channels are used to double spectral efficiency. Stable and precise polarization rotation is desirable to maintain channel separation. The compact size and low energy requirements of the proposed device enable the integration of multiple independent polarization controllers directly within coherent transceivers, something impractical with bulky or high-voltage LiNbO₃ systems.

### GHz-Speed Polarization Scrambling to Suppress Fading in Fiber Systems

Polarization fading in optical fibers can degrade link performance, particularly under fast-changing environmental conditions. This device enables scrambling at tens of gigahertz, effectively randomizing polarization faster than environmental disturbances can introduce correlation, thereby mitigating polarization-mode dispersion (PMD) and fading-induced penalties.

### State Preparation for Quantum Photonics

Quantum photonic systems require precise, low-loss control over photon polarization for state preparation and entanglement. The present device provides nanosecond-to-picosecond control, enabling dynamic adjustment between quantum states within the same experimental sequence. The high optical damage threshold of III-nitrides supports both single-photon and high-intensity quantum light sources without inducing unwanted decoherence.

### Real-Time Polarization Switching in LiDAR or Imaging Systems

Polarization diversity can be used in LiDAR to enhance material discrimination and suppress specular reflections. The proposed device allows frame-to-frame polarization switching in scanning LiDAR systems, and in imaging, enables instantaneous switching between orthogonal polarization channels to improve contrast in turbid or scattering media.

### Dense Integration for Photonic Processors

The ultra-compact footprint permits hundreds of polarization control elements to be integrated onto a single photonic integrated circuit (PIC), with negligible cumulative capacitance and low total energy demand. This makes it practical to embed polarization control in optical neural networks, reconfigurable optical switches, and programmable photonic signal processors.

Conventional frequency shifters based on acousto-optic modulation utilize a traveling refractive index grating in a bulk crystal, such as TeO₂ or quartz, to diffract an incident optical beam into a new spatial mode with a Doppler frequency shift equal to the acoustic drive frequency fₐ. The first-order diffracted light experiences a frequency change of ±fₐ, where the sign depends on whether the optical beam and acoustic wave are co-propagating or counter-propagating. While this method is widely used in heterodyne detection, carrier offsetting, and frequency tagging, traditional implementations require large interaction lengths (often several centimeters) and high RF drive powers to achieve single-pass efficiencies exceeding 50%. These constraints limit integration potential, increase thermal load, and impose practical bandwidth limits.

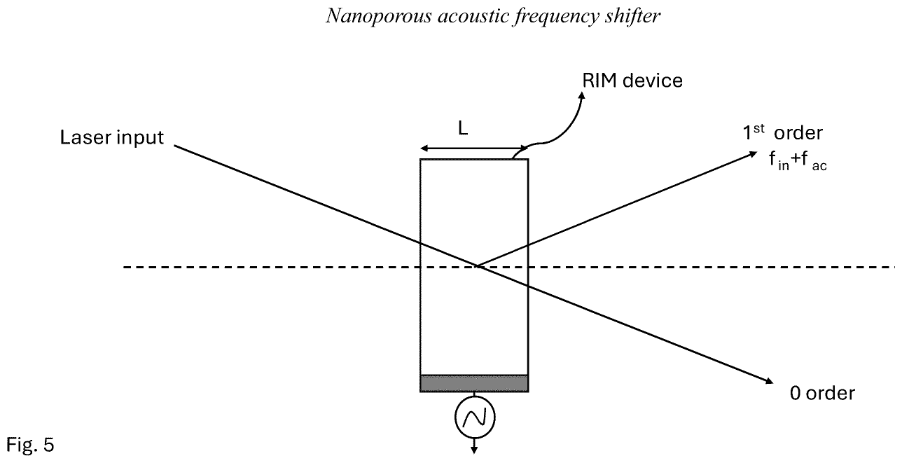

The present example as shown in FIG. 5, implements frequency shifting within a nanoporous medium, such as III-nitride medium engineered for enhanced effective refractive index modulation via the synergistic action of (1) the photoelastic effect from acoustic strain and (2) dynamic pore refilling synchronized to the acoustic cycle. The pores have diameters much smaller than the optical wavelength, ensuring the optical mode perceives the film as a homogeneous medium while still enabling rapid, reversible changes in effective refractive index during acoustic compression and rarefaction.

A traveling acoustic wave with wavelength Λ_{ac} and frequency fₐ is launched across the film using interdigital transducers (IDTs) or other transduction methods. The moving index modulation has an effective amplitude:

$$Δ {n}_{total} = Δ {n}_{PE} + Δ {n}_{pore}$$

where Δn_{PE} arises from the photoelastic tensor response and Δnₚₒᵣₑ results from modulation of pore fill fraction f(t) within each acoustic cycle. The enhanced Δnₜₒₜₐₗ increases the coupling coefficient κ between the incident and diffracted optical waves:

$$κ = \frac{πΔ {n}_{total}}{λcos {θ}_{B}}$$

with λ being the optical free-space wavelength and θB the Bragg angle for the given acoustic geometry.

The single-pass diffraction efficiency into the first order is:

$$η = {sin}^{2} ( κ L )$$

where L is the acoustic-optical interaction length. In traditional AOMs, Δnₜₒₜₐₗ is typically limited to ˜10⁻⁵-10⁻⁴, requiring L on the order of centimeters for high efficiency. In this nanoporous III-nitride system, Δnₜₒₜₐₗ in the range of 10⁻³ to 10⁻¹ enables η>80% in lengths of only a few hundred microns. This reduction in interaction length directly translates to lower RF drive power, higher thermal stability, and compatibility with photonic integrated circuit (PIC) integration.

In operation, an optical beam incident at the Bragg angle is diffracted into the first order with a frequency shift: fₒᵤₜ=fᵢₙ±f_{ac}

This shift is precise, tunable via the RF drive frequency, and inherently phase-coherent, making the device suitable for:

Heterodyne detection—generating a stable offset between two optical fields for phase-sensitive detection.

Carrier offsetting—shifting the optical carrier by several MHz to GHz for dense wavelength division multiplexing (DWDM) channel management.

Frequency tagging—labeling beams in multi-path interferometers or remote sensing systems for unambiguous path identification.

Optical frequency synthesis—building offset-lock loops for laser frequency stabilization.

By exploiting the energy-controlled dynamic pore refilling mechanism, the present example delivers an order-of-magnitude higher coupling strength than conventional AOMs, enabling sub-millimeter-scale frequency shifters with gigahertz-scale tuning range, low RF power consumption, and straightforward integration with other on-chip optical elements. This combination of high efficiency, small form factor, and energy flexibility (electric, acoustic, or hybrid actuation) addresses the long-standing challenges of size, power, and thermal stability in frequency shifting applications.

In traditional pulse picking systems, individual pulses are selected from a mode-locked laser train operating at repetition rates ranging from tens of megahertz to multiple gigahertz. The conventional implementation typically employs a bulk Pockels cell placed between two crossed polarizers. In the absence of an applied voltage, the Pockels cell leaves the incident polarization unchanged, causing the light to be blocked by the output polarizer. When a voltage is applied, the Pockels cell acts as a waveplate, rotating the polarization of the targeted pulse so that it passes through the second polarizer. Timing electronics synchronize the voltage pulse with the arrival of the optical pulse to be selected. While effective, this approach suffers from several limitations: bulk crystals such as KDP or BBO require centimeter-scale interaction lengths to achieve a π phase shift, half-wave voltages Vπ often exceed hundreds of volts, and the high capacitance of the large-aperture electrodes constrains the electrical rise and fall times, limiting sub-nanosecond operation. Additionally, thermal load from high optical and electrical power can degrade performance, and the cost and footprint of such assemblies restrict their use in densely integrated photonic systems.

Nanoporous III-nitride materials exhibit an anisotropic effective refractive index because the pores do not respond uniformly to external stimuli such as an applied electric field. When an external electric field is applied, the shape and distribution of the nanopores are altered more significantly in the direction parallel to the field compared to the perpendicular direction. This anisotropic deformation arises from the intrinsic piezoelectric nature of III-nitrides, which induces preferential strain along the field axis.

As a result, the effective refractive index change (Δnₑff) is larger in the parallel direction than in the perpendicular direction. This anisotropy can be exploited to manipulate the polarization state of light propagating through the material. By carefully designing the pore morphology and orientation, the material can preferentially modify either the transverse electric (TE) or transverse magnetic (TM) modes, thereby functioning as a polarization-controlling element.

To enhance the anisotropic effective refractive index response, elongated or directionally deformable pore geometries are desirable. For example, pores with cylindrical, elliptical, or stretched shapes aligned with the electric field direction are more effective than isotropic or spherical pores. Such anisotropic pore architectures amplify the refractive index difference between the parallel and perpendicular field orientations, enabling stronger polarization-dependent modulation and more efficient control of the optical wavefront.

Importantly, the degree of anisotropy is also influenced by the crystallographic orientation of the III-nitride layer. In particular, c-plane (0001) oriented III-nitrides exhibit a stronger piezoelectric response compared to non-polar (m-plane, a-plane) or semi-polar orientations. This is because the spontaneous and piezoelectric polarization fields are maximized along the c-axis, leading to greater strain-induced pore deformation when an external electric field is applied. Consequently, nanoporous III-nitrides grown on the c-plane tend to achieve larger anisotropic effective refractive index changes (Δn_{eff}), making them especially attractive for polarization control and high-efficiency electro-optic modulation.

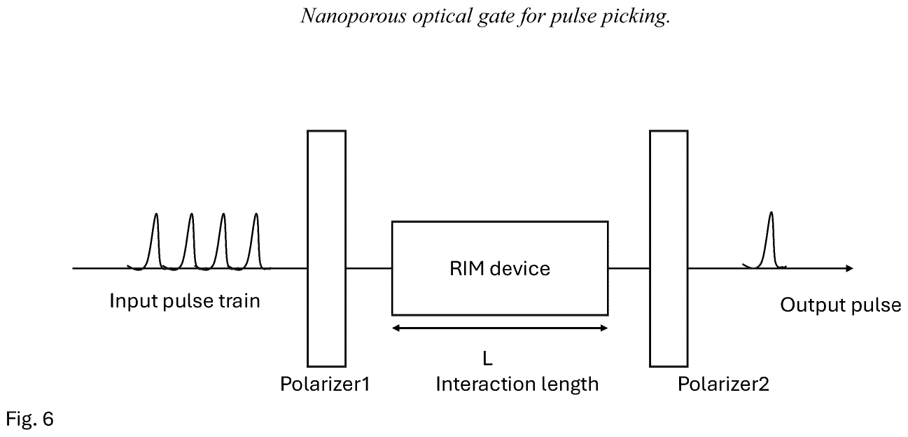

In this example, shown in FIG. 6, the bulk Pockels cell is replaced by a nanoporous piezoelectric material such as III-nitride optical gate, wherein the refractive index is modulated through energy-controlled dynamic pore refilling. The active medium comprises a thin-film waveguide or free-space aperture section fabricated from nanoporous GaN, AlN, InN or related III-nitride alloys, with sub-wavelength pores of diameter less than optical wavelength, ensuring that the structure behaves as an optically homogeneous medium with negligible scattering losses. The application of an electrical, acoustic, or hybrid energy stimulus modifies the fill fraction of the pores on nanosecond to sub-nanosecond timescales, producing a large effective refractive index change (Δn_{eff}) of up to 0.3. This refractive index shift imparts a phase change Δϕ=(2π/λ) Δn_{eff} L, where L is the interaction length, allowing a π phase shift to be realized in as little as 2-80 μm depending on the modulation depth orders of magnitude shorter than bulk crystal devices.

In the “off” state, the device is phase-biased to cause destructive interference or polarization extinction, depending on the configuration. When the control signal is applied, the refractive index transitions to the “on” state, permitting the selected pulse to pass with minimal insertion loss. The short interaction length yields femtofarad-scale capacitance, enabling operation at repetition rates exceeding 50-80 GHz, with sub-volt drive levels achievable through optimized optical-electrical field overlap. The wide bandgap of III-nitrides (≥3 eV) affords broad spectral transparency from ultraviolet to infrared, as well as high optical damage thresholds, making the device suitable for high-power laser pulse selection.

In an example, a mode-locked laser at 1550 nm with a 10 GHz repetition rate is down-sampled to 100 MHz output by gating one in every hundred pulses. A device with m active length and Δn_{eff}=0.3 achieves a π shift with less than 0.5 V drive, a switching window of 200 ps, an extinction ratio exceeding 40 dB, and insertion loss below 1 dB. The use of traveling-wave electrodes matched to the optical group velocity eliminates microwave walk-off at high speed. This nanoporous III-nitride pulse picker thus combines the low-loss, high-extinction, and fast response of bulk Pockels systems with the compactness, low-voltage operation, and integration potential of modern photonic devices, enabling scalable deployment in optical computing, LiDAR, high-repetition-rate laser systems, and quantum photonic processors

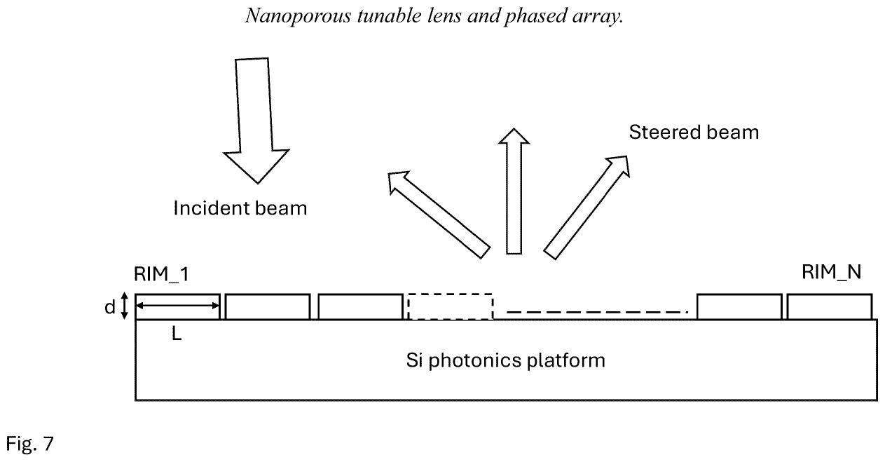

In an example shown in FIG. 7, a tunable optical element comprises a nanoporous piezoelectric material layers, like III-nitride film engineered with sub-wavelength pores distributed within a thin-film or metasurface lens structure. The base material, selected from GaN, AlN, InN or III-nitride alloys, retains its wurtzite crystal symmetry to preserve strong electro-optic and piezoelectric responses. The pores are designed to be dynamically refilled under an applied stimulus, electrical, acoustic, or optical altering the local effective refractive index Δn_{eff} across the lens profile.

The focal length f of such a lens is determined by the local phase delay ϕ(r) imposed as a function of radial coordinate r, with

$$∅ ( r ) = \frac{2 π}{λ} \int {n}_{eff} ( r , z ) dz .$$

By modulating Δn_{eff} from ˜0.001 in fine adjustment mode to ˜0.3 in high-contrast mode, the device enables focal length changes exceeding an order of magnitude without mechanical displacement.

In an optical phased array configuration, as in FIG. 7, an array of individually addressable nanoporous phase shifters, RIM-1 . . . RIM-N, imposes a controlled phase gradient ∂ϕ/∂x across the aperture, steering the output beam according to θ≈λ(∂ϕ/∂x)/(2π). The large achievable Δn_{eff} reduces the required physical length, L, of each phase shifter to the 2-80 μm range, minimizing RC constants and enabling modulation bandwidths above 50 GHz.

Because the pores are well below the scattering limit, optical efficiency remains high (>95%) across the visible and infrared spectrum. The high bandgap (>3 eV) of III-nitride materials allows operation with high optical intensities without photorefractive degradation, making the device suitable for high-power LiDAR, and free-space optical communication systems. Switching times in the sub-nanosecond regime allow for real-time beam steering in fast-moving platforms or rapid focal tuning in adaptive imaging systems.

In one implementation, a metasurface beam steering device integrated onto a silicon photonics platform employs a one-dimensional array of 128 nanoporous III-nitride phase shifters, each 5 μm long and capable of Δn_{eff}=0.2. This configuration achieves a steering range of ±15° at 1550 nm with update rates exceeding 1 GHz, outperforming LC-OPAs by three orders of magnitude in speed while maintaining low drive voltages (<1 V) and negligible thermal drift.

This example replaces slow and mechanically complex tunable optics with a robust, solid-state, integration-ready platform, providing a pathway to high-speed, high-precision beam steering and tunable lenses for LiDAR, AR/VR, free-space communication, quantum light routing, and adaptive imaging.

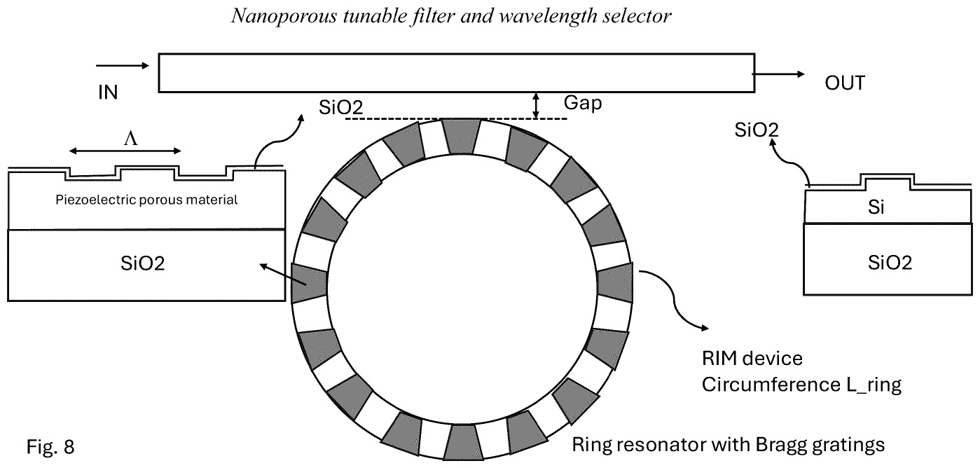

In an example as illustrated in FIG. 8, a tunable optical filter comprises a nanoporous piezoelectric material, such as III-nitride active layer integrated within the mode volume of a ring resonator or embedded into the high-index regions of a Bragg grating. The pores, with diameters below the optical wavelength, ensure no scattering while enabling dynamic control of the effective refractive index through rapid energy-controlled pore refilling. The host III-nitride material (e.g., GaN, AlN, InN or alloy variants) preserves high transparency and strong electro-optic/piezoelectric coefficients, allowing the pore-filling mechanism to act in synergy with intrinsic Pockels tuning.

For a ring resonator of circumference L_{ring}, the resonance wavelength is given by

$${λ}_{m} = \frac{{n}_{eff}}{m} {L}_{ring}$$

where m is the mode number. A local index change Δn_{eff} shifts the resonance by

$$Δ {λ}_{m} ∼ {λ}_{m} \frac{Δ {n}_{eff}}{{n}_{eff}}$$

With achievable Δn_{eff} values from 0.001 (fine tuning) to 0.3 (large jumps), the device can shift the resonance by multiple nanometers in the telecom band orders of magnitude beyond the range of conventional carrier-based or thermo-optic tuning.

In a Bragg grating filter, the central reflection wavelength follows

$${λ}_{B} = 2 {n}_{eff} Λ$$

where Λ is the grating period. Rapid pore filling changes n_{eff}, thereby tuning λ_{B} at sub-nanosecond speeds without introducing significant loss. This enables sweeping a narrowband filter across dozens of DWDM channels or rapidly changing spectral passbands in hyperspectral imaging systems.

Example implementation: a 10 μm-radius GaN ring resonator clad with a 200 nm-thick nanoporous active layer achieves Δn_{eff}=0.1 under <1 V drive, resulting in Δλ≈15 nm shift at 1550 nm with <1 dB insertion loss. Switching speeds exceed 50 GHz when driven with traveling-wave electrodes matched to the optical group velocity, allowing real-time channel hopping in reconfigurable optical add-drop multiplexers (ROADMs).

This example eliminates the thermal inertia and power dissipation of heaters, avoids free-carrier absorption penalties, and provides tuning ranges large enough to reconfigure entire DWDM (Dense Wavelength Division Multiplexing) bands or spectral windows in hyperspectral sensors. It enables dense integration of thousands of tunable filters on a single chip, allowing ultra-compact, low-power, and high-speed spectral reconfiguration across telecommunications, imaging, spectroscopy, and quantum photonics.

Optical isolators are desirable in protecting lasers and sensitive photonic circuits from back reflections, which can destabilize or damage the source. The most widely used approach is the Faraday isolator, which exploits the nonreciprocal Faraday rotation of polarization in a magneto-optic crystal (e.g., terbium gallium garnet, TGG) placed in a strong magnetic field. The rotation angle is fixed by the Verdet constant V and the path length L as θ=VBL, where B is the magnetic flux density.

While effective, Faraday isolators face several limitations:

Magnetic Bias Requirement They require permanent magnets or electromagnets, adding bulk, weight, and electromagnetic interference concerns.

Integration Limitations The bulk crystal and magnet assembly are incompatible with standard photonic integrated circuit (PIC) fabrication, making on-chip isolation extremely challenging.

Limited Tunability The rotation is fixed by the material and magnetic field; active control requires complex designs.

Thermal Sensitivity Verdet constants and birefringence can drift with temperature, impacting isolation ratio.

An alternative method explored in research uses temporal refractive index modulation to create synthetic nonreciprocity. This is achieved with traveling-wave phase modulators that shift the phase of forward-propagating light differently from backward-propagating light. However, conventional modulators in LiNbO₃ or silicon often provide small Δn_{eff} (≤10⁻⁴), requiring long interaction lengths and high drive power, limiting isolation strength.

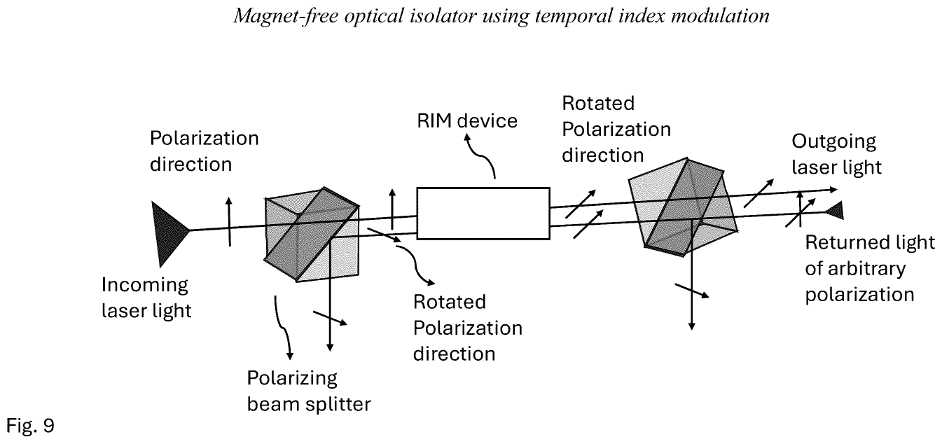

In an example as in FIG. 9, a magnet-free optical isolator is realized using a nanoporous piezoelectric material, such as III-nitride waveguide modulator engineered for large, high-speed refractive index modulation via energy-controlled dynamic pore refilling. The active section is patterned to support a traveling temporal index perturbation, launched either by synchronized RF electrodes (electro-optic drive) or acoustic transducers (acousto-optic drive).

The time-varying refractive index is expressed as:

$$n ( z , t ) = {n}_{0} + Δ {n}_{eff} cos ( \frac{2 π}{Λ} z - Ω t )$$

where Λ is the spatial period, Ω is the modulation frequency, and Δn_{eff} is the peak modulation depth.

For forward-propagating light, the phase velocity can be matched to the traveling modulation, enabling strong mode conversion or frequency shifting. Backward-propagating light encounters a mismatched phase velocity, leading to negligible coupling and high isolation.

With dynamic pore refilling, Δn_{eff} values in the range (0.001 to 0.3) are achievable, orders of magnitude higher than conventional modulators allowing:

Short interaction lengths (<1 mm) for ≥40 dB isolation.

Low drive voltage (<1 V) due to high optical/electrical field overlap.

Broadband operation high modulation depth allows phase-matched isolation over tens of nanometers of optical bandwidth.

Integration onto PICs thin-film III-nitride process allows co-fabrication with lasers, detectors, and passive waveguides.

Example: In a 500 μm GaN-on-sapphire waveguide at 1550 nm, a traveling-wave electrode pair driven at 10 GHz produces Δn_{eff}=0.02. The forward light experiences strong phase-matched coupling to a frequency-shifted mode, while the backward light sees <0.1% coupling, resulting in 45 dB isolation with <100 mW RF power.

This example replaces magnet-based isolation with an all-electronic, integrable, and tunable solution, removing size, weight, and magnetic interference while enabling high-speed reconfigurable nonreciprocity for optical communications, LiDAR, quantum photonics, and on-chip laser protection.

Photonic crystals (PhCs) and metamaterials manipulate light via periodic modulation of refractive index or effective permittivity at sub-wavelength scales. By introducing a photonic bandgap, they can reflect specific wavelengths while transmitting others. Traditionally, dynamic control in such structures has been achieved through:

Thermo-optic tuning—Local heating changes the refractive index of a constituent material, shifting the bandgap. For example, in silicon PhCs, heating changes nnn via Δn_{TO}≈1.86×10−4·ΔT (per Kelvin).

Free-carrier injection or depletion—In semiconductors like silicon or InP, carriers generated via electrical injection or optical pumping modify the refractive index through plasma dispersion.

Liquid crystal infiltration—Infiltrating LC molecules into the holes of 2D PhCs allows index control by reorienting the LC with an electric field.

While functional, these methods face significant limitations:

Slow response—Thermo-optic effects are in the microsecond-millisecond regime due to heat diffusion; LC reorientation takes milliseconds.

Small Δn—Free-carrier and thermo-optic tuning typically achieve Δn<10⁻³, requiring large device footprints for substantial spectral shifts.

Integration challenges—LC infiltration adds packaging complexity, while heating elements add thermal crosstalk and high power consumption.

Loss increase—Free-carrier absorption degrades Q-factors in resonant PhC cavities, reducing efficiency in optical logic or topological devices.

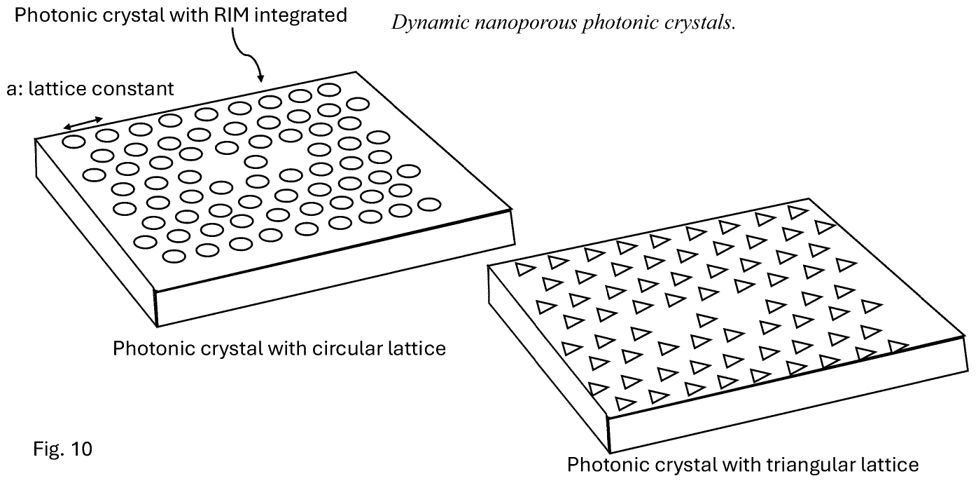

In an example as in FIG. 10, a dynamic photonic crystal is fabricated entirely from nanoporous piezoelectric material, where refractive index modulation is achieved through an energy-controlled mechanism. The photonic crystal's periodicity is defined lithographically, with pore diameters smaller than the operational optical wavelength to maintain optical homogeneity within each region while enabling rapid modulation. Lithographic masking allows the pores within the photonic crystal slab to be patterned in circular, triangular, hexagonal, or arbitrary shapes, two of such shapes shown in FIG. 10.

An external stimulus electrical (via interdigitated electrodes), acoustic (via surface acoustic waves), or optical (via ultrafast pump) modifies the fill fraction of the nanopores, changing the effective refractive index contrast between high- and low-index regions of the photonic crystal. The bandgap position λ_{BG} is governed by: λ_{BG}=2a·n_{avg}
where a is the lattice constant and n_{avg} is the average refractive index of the unit cell. A modulation Δn_{eff} of 0.001-0.3 enables instantaneous bandgap shifts of tens of nanometers, transitioning the device from transmissive to reflective states in sub-nanosecond timescales.

Unlike thermo-optic or LC methods, the dynamic pore refilling mechanism is inherently solid-state and GHz-speed capable, allowing for:

All-optical logic gates—A control pulse triggers index modulation, switching a photonic crystal waveguide from pass to block state for data routing.

Topological photonics—Rapid modulation of the refractive index pattern alters the topology of edge states, enabling reconfigurable, backscattering-immune light transport.

Wavelength-selective modulators—Real-time reconfiguration of photonic bandgap for DWDM channel add/drop without thermal drift.

Example: A GaN-based 2D photonic crystal slab with a=450 nm, neff=2.1, and a baseline bandgap at 940 nm is driven with a 20 GHz acoustic wave, inducing Δn_{eff}=0.1. The bandgap shifts by 45 nm within 50 ps, toggling reflectivity from <5% to >90% for the target channel. This performance is achieved in a monolithically integrated platform without magnets, thermal heaters, or liquid infiltration.

This example enables ultrafast, high-contrast photonic crystal switching suitable for high-speed optical interconnects, reconfigurable beam steering, and next-generation topological photonic circuits—functions that conventional thermal or liquid-crystal-tuned PhCs cannot achieve at similar speed and compactness

In high-speed optical systems, dispersion compensation and chirp control are desirable to counteract pulse broadening and shape ultrafast signals. Conventionally, this is achieved through:

Chirped fiber Bragg gratings (CFBGs) The grating period is varied along the fiber to impose a wavelength-dependent delay. While effective, CFBGs are fixed-function, physically long (tens of centimeters to meters), and cannot be reconfigured dynamically.

Thermo-optic waveguide dispersion shapers—Integrated waveguides with heaters locally modify refractive index, tuning the group delay. However, the thermo-optic coefficient of materials like SiO₂ or Si is small (˜1-2×10-5/K), requiring large temperature swings, milliwatts to watts of heating, and suffering from microsecond-millisecond response times.

Electro-optic phase modulators in segmented configurations By cascading multiple LiNbO₃ phase modulators, the spectral phase can be tailored, but LiNbO₃ requires centimeter-scale lengths per segment, high drive voltages (Vπ≈3-5 V for waveguide devices), and still struggles with GHz-rate reprogramming for per-pulse chirp shaping.

These methods face several challenges:

Slow tuning (thermal methods) or large footprints (LiNbO₃ or fiber gratings).

High power consumption, especially in dense photonic integration.

Limited dynamic range of dispersion tuning changes in group index (ng) are typically <0.01, limiting the achievable chirp rates and compensation strength.

Incompatibility with ultrafast per-pulse control, making them unsuitable for adaptive optics in terabit systems or real-time ultrafast waveform synthesis.

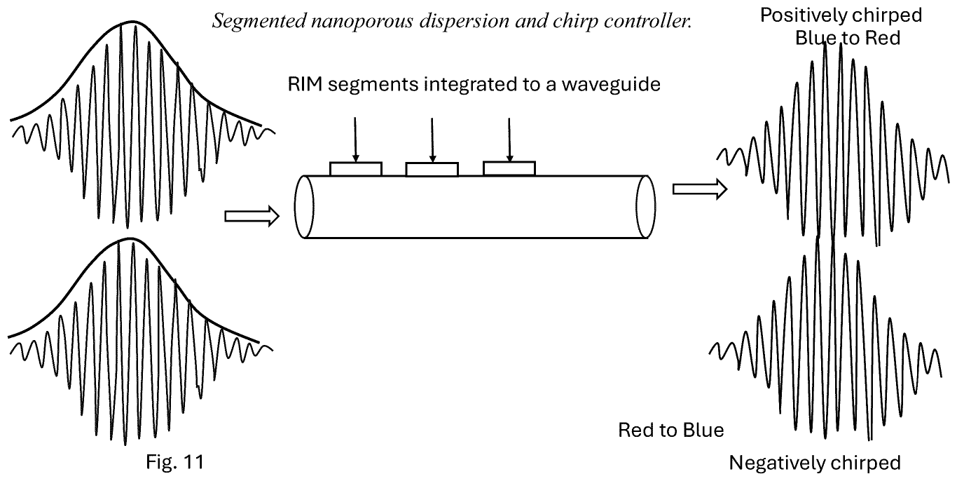

In an example, shown in FIG. 11, a segmented waveguide is formed from nanoporous piezoelectric material using RIM device, such as III-nitride films (e.g., GaN, AlN, InN or ternary alloys) integrated into a photonic chip. The waveguide contains multiple independently addressable sections, each with sub-wavelength-scale pores. The pores are dynamically refilled using energy-controlled stimuli, electrical fields via traveling-wave electrodes, acoustic waves via IDTs, or optical pumping altering the effective refractive index (Δn_{eff}) and hence the group index (n_{g}) in each segment.

The local group delay imparted to a wavelength λ in segment i is:

$${τ}_{i} ( λ ) = \frac{{n}_{g , i} ( λ )}{c} {L}_{i}$$

By programming Δn_{eff} across the segments, the aggregate group delay versus wavelength profile can be tailored to achieve positive or negative dispersion, arbitrary chirp functions, or higher-order phase shaping.

Because dynamic pore filling can achieve Δneff values of 0.001-0.3, the corresponding change in group index Δn_{g} can exceed 0.05, enabling compact dispersion compensation over just hundreds of microns instead of centimeters or meters. For example, a 500 μm section with n_{g} tunable from 3.6 to 3.65 can impart >80 fs/nm delay variation, enough to fully compress or stretch sub-100 fs pulses in fiber-optic or free-space ultrafast systems.

Dispersion compensation and pulse compression is desirable whenever very short pulses are passing a lot of optical material, e.g. in a microscope for Multi-Photon-Excitation (MPE) microscopy. Positive GVD (Group Velocity Dispersion) in a MPE microscope of around 13 000 fs², for example, causes a broadening of a 100 fs pulse to 370 fs at 800 nm. The multi-photon absorption cross-section depends on the pulse width. High dispersion results in temporal broadening of the pulse, which distinctly interferes with the measurement conditions.

### Advantages Over Conventional Methods:

Ultrafast reconfiguration-sub-nanosecond index tuning allows per-pulse chirp shaping for mode-locked lasers at multi-GHz repetition rates.

Low power operation-electric field or acoustic drive requires orders of magnitude less power than resistive heaters.

High dispersion dynamic range larger achievable Δn_{g} than thermal or electro-optic methods in LiNbO₃.

Dense integration micron—scale active sections enable hundreds of independent dispersion tuning elements on a single PIC (Photonic Integrated Circuit), ideal for coherent transceivers, adaptive optics, and optical arbitrary waveform generation.

Example: In a 6-segment GaN RIM waveguide at 1550 nm, each 200 μm segment can tune Δneff=0.1 within 200 ps, providing programmable dispersion from −2500 ps/nm to +2500 ps/nm across the device. The total footprint is under 2 mm, with femtofarad-scale capacitance for ≥50 GHz modulation bandwidth.

This example enables fast, reconfigurable dispersion and chirp control that overcomes the speed, size, and power limits of CFBGs, thermo-optic devices, and centimeter-scale LiNbO₃ modulators, making it practical for ultrafast coherent systems, LiDAR pulse shaping, and quantum photonic state engineering.

Hyperspectral cameras capture images across hundreds of narrow wavelength bands, enabling material identification, chemical mapping, and environmental monitoring. A tunable filter is used to select each wavelength band sequentially. Conventional implementations include:

Liquid crystal tunable filters (LCTFs): Use electrically controlled birefringence to shift the passband. These have moderate tuning ranges (400-1700 nm), but their switching speeds are slow (milliseconds) and optical throughput can be limited due to multiple polarizers and imperfect retardance control.

Acousto-optic tunable filters (AOTFs): Use a traveling acoustic wave in a birefringent crystal (e.g., TeO₂) to Bragg-diffract specific wavelengths into the detector. AOTFs offer microsecond switching, but require centimeter-long crystals, high RF drive power, and have limited aperture for wide field-of-view imaging.

Fabry-Perot etalons with piezo control: Change cavity spacing to tune transmission wavelength. These provide high spectral resolution but suffer from mechanical limitations, slow tuning (hundreds of microseconds to milliseconds), and susceptibility to vibration and thermal drift.

Challenges with these Methods Include:

Limited tuning speed milliseconds for LCTFs, microseconds for AOTFs.

High power consumption for large apertures.

Physical bulk and weight, especially in airborne or spaceborne systems.

Limited spectral range in a single device without changing materials or optics.

Polarization dependence in many designs, complicating calibration.

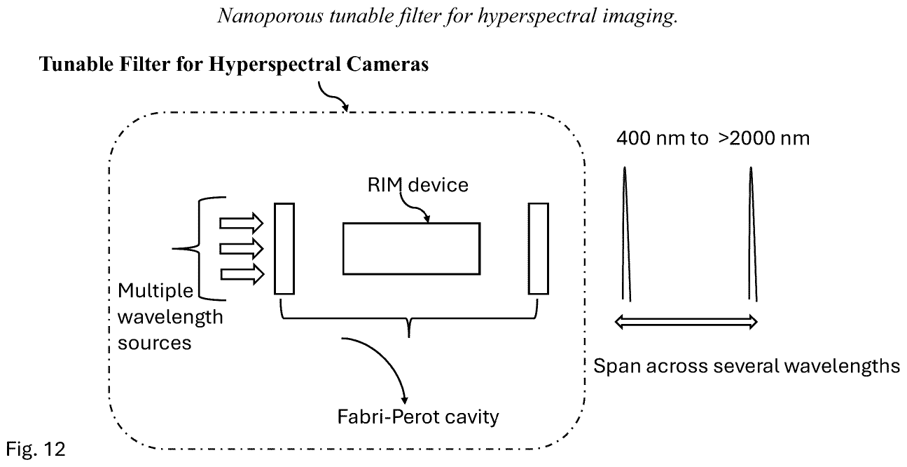

In an example, as shown in FIG. 12, a nanoporous piezoelectric layer, like III-nitride thin-film, tunable filter is integrated as the front-end wavelength selector in a hyperspectral camera system. The active layer, made from GaN, AlN, InN or AlGaN or AlGaScN alloys, incorporates pores smaller than optical wavelength in diameter, maintaining low scattering and high optical quality across the visible to short-wave infrared (SWIR) range.

The filter is implemented as a planar Fabry-Perot resonator or an integrated Bragg grating whose effective refractive index is dynamically tuned via energy-controlled pore refilling. Applying an electric field, acoustic wave, or optical pump changes the refractive index of the nanoporous layer (Δneff up to 0.3), which shifts the resonance wavelength according to:

$$Δ λ = λ \cdot \frac{Δ {n}_{eff}}{{n}_{eff}}$$

For neff=2.0 and Δn_{eff}=0.1, a 5% fractional wavelength shift is achieved, enabling broadband tuning from 400 nm to >2000 nm achieves percent-level, high-speed tuning around the design wavelength (e.g., 5-15% depending on Δneff). Full 400-2000 nm coverage is realized by tiling multiple devices with staggered centers and/or order-selection (FP or Bragg), while the RIM mechanism provides nanosecond-class tuning within each band.

Because the index modulation mechanism is non-thermal and field-driven, tuning times are in the nanosecond to sub-microsecond range, representing a 10³-10⁶× speed improvement over LCTFs and Fabry-Pérot mechanical actuators. The large achievable Δneff also allows wide spectral shifts without mechanically varying the cavity length or grating period.

### Advantages Over Conventional Filters Include:

Broad spectral coverage (visible to SWIR) in a single device without changing crystals.

Ultrafast tuning—<1 μs for full-range sweep, enabling real-time hyperspectral video.

Compact, low-power operation suitable for drones, satellites, and portable instruments.

Polarization independence when designed with isotropic pore distribution.

Integration potential—can be fabricated directly on CMOS detector arrays for monolithic hyperspectral imaging chips.

Example: A 10 μm thick nanoporous GaN Fabry-Pérot filter with 90% fill factor pores, operating at λ=800 nm, achieves a 50 nm tuning range with 5 V drive, sub-100 ns switching, and <1 dB insertion loss. When mounted over a 1024×1024 pixel array, the filter enables 500 spectral bands at 10 kHz frame rates—performance unattainable with mechanical or liquid crystal tuners.

This example enables hyperspectral cameras to transition from slow, sequential scanning instruments to real-time, broadband spectral imagers, unlocking applications in defense surveillance, precision agriculture, environmental monitoring, industrial process control, and biomedical diagnostics.

On-chip quantum gates form the backbone of photonic quantum information processing, enabling logic operations, entanglement generation, and state routing at the single-photon level. These gates rely on ultra-low-loss, high-fidelity modulation to preserve quantum coherence and minimize photon loss or noise.

### Traditionally, On-Chip Quantum Gates Use:

Thermo-optic phase shifters—slow (ps-ms), dissipative, and thermally noisy, which can induce phase drift and degrade quantum interference visibility.

Carrier-based modulators—faster (ns) but introduce significant optical absorption, free-carrier noise, and index fluctuations detrimental to single-photon coherence.

LiNbO₃ electro-optic devices—low loss and fast, but require millimeter-scale interaction lengths or high voltages due to relatively small electro-optic coefficients, and are challenging to monolithically integrate with other quantum photonic materials.

These conventional technologies face inherent speed-loss trade-offs, large footprints, and integration difficulties, all of which limit the scalability and fidelity of quantum photonic processors.

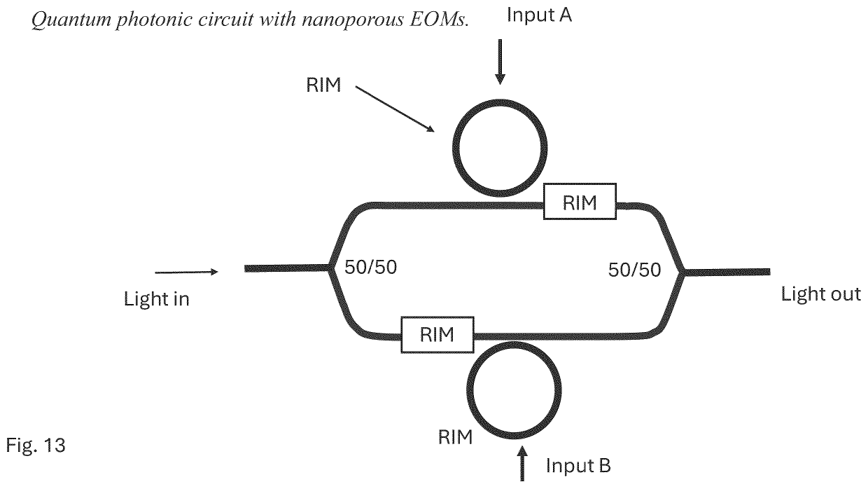

In the present example, as shown in FIG. 13, a fundamentally different electro-optic modulator architecture is provided, employing a nanoporous, non-centrosymmetric piezoelectric material, such as gallium nitride (GaN), aluminum nitride (AlN), Indium Nitride (InN), gallium-aluminum-scandium nitride (GaAlScN), or their alloys. The nanoporous structure is engineered such that the pore diameters are well below the optical wavelength eliminating scattering and ensuring homogeneous optical behavior.

Quantum logic operations are realized by embedding the nanoporous electro-optic film into interferometric quantum circuits (e.g., Mach-Zehnder, multiport beam splitters) or switching waveguides or ring resonators. The dynamic pore filling mechanism—triggered by an applied electrical, acoustic, or optical stimulus—produces an effective refractive index change Δneff up to 0.3. This large index change drastically reduces the active device length required for a π phase shift:

$$L π = \frac{λ}{2 Δ {n}_{eff}}$$

For telecom quantum photonics (λ=1550 nm), Δneff=0.1 yields Lπ≈7.75 μm, orders of magnitude shorter than LiNbO₃ or thermo-optic equivalents.

Because the active length is in the micron range, the device capacitance is in the femtofarad regime, enabling sub-nanosecond switching with drive voltages below 1 V. This allows quantum gates to operate at repetition rates >50 GHz, far exceeding the speed limits of thermal or carrier-based devices, while maintaining insertion loss below 0.5 dB and extinction ratios above 40 dB. The wide bandgap of III-nitrides (>3 eV) ensures zero two-photon absorption at telecom wavelengths, protecting fragile quantum states from excess loss and noise.

### Advantages for Quantum Photonics:

High fidelity: Low loss and absence of carrier noise preserve single-photon coherence and entanglement.

Scalable integration: III-nitride films can be monolithically grown or bonded onto quantum PIC substrates (SiN, AlN, GaN, AlScGaN, InN).

Fast feed-forward capability: Sub-nanosecond switching supports real-time quantum error correction and adaptive measurements.

Compact footprint: Enables dense packing of hundreds of quantum gates on a single chip without thermal crosstalk.

Example Implementation: In a 4×4 universal quantum linear optics processor, nanoporous GaN phase shifters are inserted into each interferometric stage. With Δneff=0.05, each π phase shift section measures <15 μm, allowing a full processor footprint <2 mm² with all gates operating at 40 GHz and >99% quantum interference visibility.

This example enables high-speed, high-fidelity on-chip quantum gates that overcome the speed, loss, and scaling challenges of traditional photonic quantum logic, unlocking new architectures for large-scale quantum computation, secure communications, and quantum-enhanced sensing

Dynamic optical delay lines are for synchronizing photons in quantum networks, buffering quantum information, and implementing quantum repeaters. The core requirement is the ability to continuously and precisely vary the optical path length without introducing noise, loss, or decoherence.

### Conventional Approaches Include:

Fixed fiber coils or spiral waveguides—static delay, requiring long path lengths (meters to kilometers) and large chip area for integrated versions.

Thermo-optic delay tuning—relatively simple to implement, but slow (μs-ms), power hungry, and susceptible to thermal drift, which destroys quantum phase stability.

Carrier injection/modulation in semiconductors faster (ns) but adds free-carrier absorption and phase noise, incompatible with high-fidelity single-photon storage.

Slow-light photonic crystal waveguides—can produce large group delays but typically narrowband, with fabrication-sensitive dispersion that limits reproducibility and spectral flexibility.

These limitations prevent existing solutions from meeting the simultaneous requirements of broad bandwidth, low noise, fast tunability, and chip-scale integration for quantum memory or dynamic buffering.

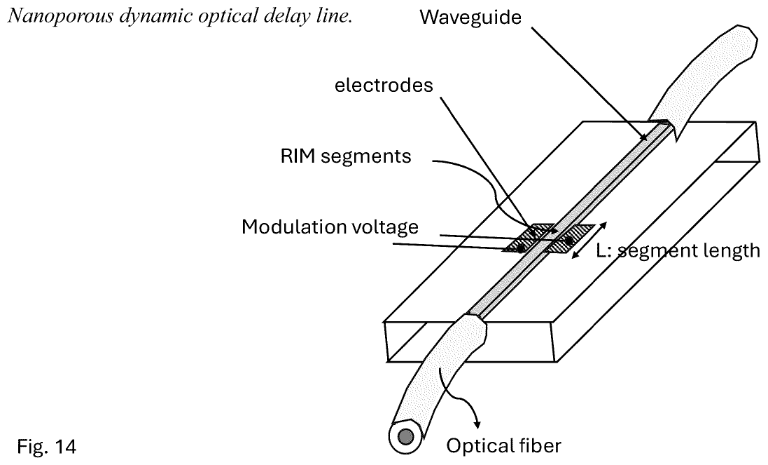

In the present example, as shown in FIG. 14, a nanoporous, piezoelectric material (e.g., GaN, AlN, InN, GaAlScN) waveguide core is employed as the active medium in a controllable optical delay line. The pores are sub-wavelength in size, ensuring homogeneous optical behavior and eliminating scattering.

The delay line operates by energy-controlled dynamic pore refilling, which modulates both the effective refractive index neff and the group index ng of the guided mode:

$${τ}_{deley} = \frac{{n}_{g}}{c} L$$

where L is the physical waveguide length and ccc is the speed of light in vacuum. By tuning neff and thus ng via electrical, acoustic, or optical control, the delay time τdelay can be varied in real-time over a wide dynamic range.

For example, in a 10 cm on-chip spiral, increasing ng from 3.5 to 4.0 via partial pore filling adds ˜1.67 ns of delay. With Δneff=0.1, dynamic delay tuning of >5 ns is possible without changing the physical footprint, enabling synchronization windows for quantum entanglement distribution or time-bin qubit alignment.

Technical Differentiators from Conventional Techniques:

Speed: Switching between delay states occurs in sub-nanosecond timescales, unlike thermo-optic tuning which is ˜10⁶× slower.

Low noise: Wide bandgap III-nitrides eliminate free-carrier absorption, preserving photon indistinguishability.

Broadband operation: Works over the full transparency range of III-nitrides (UV to IR), allowing multi-wavelength quantum memory operation.

Compact control electrodes: Micron-scale active sections embedded periodically along the spiral create a segmented delay profile with minimal capacitance.

Dynamic dispersion engineering: Independent pore-filling control in different sections enables programmable group-delay dispersion (GDD) for pulse reshaping and chirp control.

### Example Implementation:

In a quantum optical buffer operating at 1550 nm, a nanoporous GaN spiral with total length 20 cm is divided into 40 independently addressable segments. Each segment can tune Δneff by up to 0.15, providing per-segment delay increments of ˜250 ps. By controlling the activation sequence, the total delay can be varied from 0 to 10 ns with 50 ps resolution, suitable for temporal mode matching in photonic quantum computing or real-time reordering of photons in quantum communication channels.

### Impact:

This example allows for integrated, broadband, low-loss, high-speed delay control a capability that conventional fiber-based or thermal tuning methods cannot provide thereby enabling practical quantum memories, adaptive synchronization in quantum networks, and compact, reconfigurable optical buffers for both classical and quantum photonics.

Dynamic holographic projectors form and update three-dimensional optical wavefronts in real time, enabling applications such as AR/VR displays, holographic telepresence, and advanced optical trapping. The underlying principle is to modulate the phase (and sometimes amplitude) of light across a spatial light modulator (SLM) so that its far-field diffraction pattern reconstructs a desired 3D image.

### Current Systems Predominantly Use:

Liquid Crystal on Silicon (LCoS) SLMs—phase modulation achieved by voltage-induced rotation of liquid crystal molecules changes the local refractive index seen by light.

Limitations: Refresh rates typically <2 kHz (often <200 Hz for full-phase depth), unsuitable for high-speed holographic video. Susceptible to polarization sensitivity and temperature drift.

Digital Micromirror Devices (DMDs)—amplitude modulation via micromechanical tilting mirrors, with binary control.

Limitations: Require temporal or spatial dithering for phase holography, introducing latency and reducing optical efficiency.

Electro-optic crystals (e.g., LiNbO₃) in bulk or waveguide form—used in niche high-speed phase modulation setups.

Limitations: Large device size, high drive voltage (Vπ>100 V), and complex electrode driving for high-resolution arrays.

These limitations mean that high-resolution, full-complex modulation at video rates or beyond remains challenging, especially in compact, integration-friendly systems.

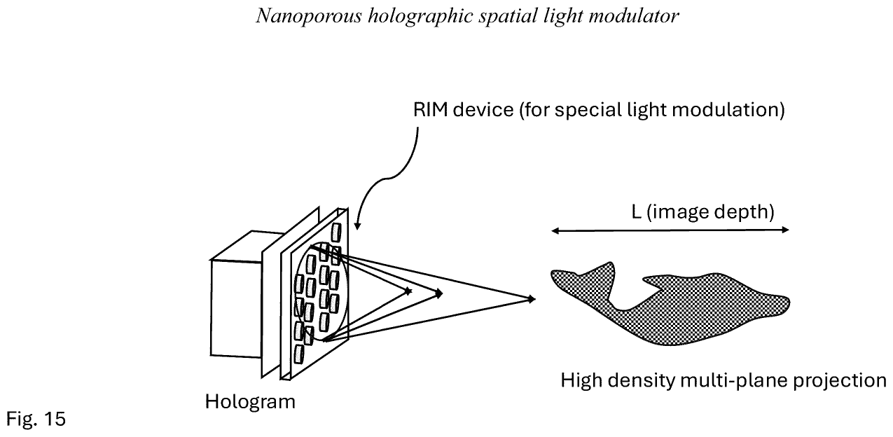

In the present example, shown in FIG. 15, a fundamentally different holographic projection platform is provided, employing a nanoporous, piezoelectric material such as gallium nitride (GaN), aluminum nitride (AlN), Indium Nitride (InN) or gallium-aluminum-scandium nitride (GaAlScN).

The active surface is formed as a dense array of independently addressable pixels, each comprising a subwavelength-scale nanoporous region whose effective refractive index (neff) can be rapidly tuned by energy-controlled dynamic pore refilling. Stimulation can be via localized electric fields (electro-optic/Pockels effect enhanced by pore refilling), surface acoustic waves (SAW-induced periodic compression/expansion of pore volumes), or optically-induced photothermal actuation.

The pixel phase shift is given by:

$$Δ ϕ ( x , y ) = \frac{2 π}{λ} Δ {n}_{eff ( x , y )} t$$

where t is the film thickness. For Δneff≈0.05 and t=1 μm, each pixel achieves >2π modulation depth in a compact vertical stack.

### Advantages Over Conventional Methods:

High-speed phase modulation: Sub-nanosecond pore-refilling response allows frame rates in the MHz regime, exceeding the refresh needs of 3D holographic video (>60 Hz) by orders of magnitude.

Full phase depth in subwavelength thickness: Unlike LCoS which requires microns of liquid crystal, the III-nitride film can achieve >2π phase shift in <1 μm thickness.

Broadband operation: III-nitrides are transparent from UV to IR, enabling holograms at multiple wavelengths, including RGB for full-color projection.

Integration-friendly: The pixelated nanoporous layer can be monolithically fabricated on semiconductor substrates, co-packaged with drive electronics, and scaled to megapixel counts.

Low voltage and power: High electro-optic coefficient with strong optical mode overlap reduces Vπ to <1 V per pixel, enabling direct CMOS driving.

### Example Performance Case:

A 1024×1024 pixel holographic panel operating at λ=532 nm uses 1 μm-thick nanoporous GaN pixels, each capable of Δneff=0.1. Localized electrode addressing produces arbitrary phase maps at >1 MHz update rates. This allows real-time hologram refresh for dynamic scenes, enabling video-rate holographic AR headsets, 3D beam shaping for optical tweezers, and holographic optical trapping in biophotonics.

This example enables a real-time, chip-scale holographic projector with unprecedented update speed, compactness, and spectral range, overcoming the refresh rate and integration limits of liquid crystal and micromirror-based SLMs.

AR/VR near-eye displays often rely on planar waveguides to transport images from a micro display into the user's field of view. Light is typically injected into the waveguide via grating couplers, prism couplers, or holographic optical elements (HOEs).

Static grating couplers (etched diffractive gratings or volume holograms) are designed for a fixed coupling efficiency and wavelength range.

Limitation: No ability to dynamically modulate coupling strength—brightness control and color tuning require external modulation elements.

Liquid crystal (LC)-based switchable gratings use electrically controlled refractive index changes in a LC layer to modulate diffraction efficiency.

Limitation: LC switching speeds are typically in the millisecond range, far too slow for real-time foveated rendering or adaptive brightness in dynamic environments.

MEMS-based scanners can steer injection beams into different regions of the waveguide.

Limitation: Moving parts add bulk, power consumption, and reliability concerns, especially in lightweight AR glasses.

The lack of a compact, ultrafast, and broadly tunable coupler limits the ability of AR/VR systems to dynamically adjust image injection for varying lighting conditions, user gaze direction, and multi-depth rendering.

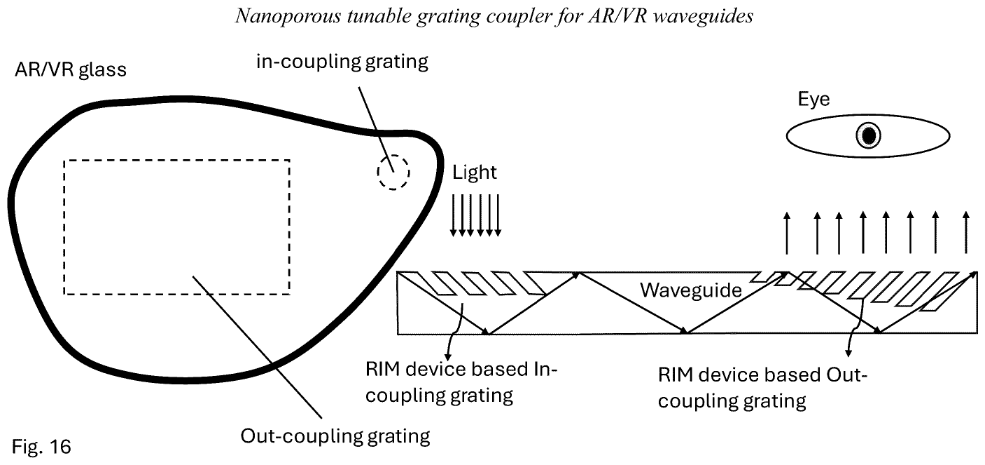

In the present example, FIG. 16, a fundamentally different waveguide coupler is provided, employing a nanoporous piezoelectric material such as gallium nitride (GaN), aluminum nitride (AlN), Indium Nitride (InN) or gallium-aluminum-scandium nitride (GaAlScN), patterned into a subwavelength grating structure directly integrated at the AR/VR waveguide input region. FIG. 16 shows an example eye glass and a grating coupled waveguide for light to the eye box.

The nanoporous grating elements have pore diameters <λ/100, ensuring effective medium behavior without scattering loss. By applying an energy-controlled dynamic pore refilling stimulus (electrical, acoustic, or optical), the effective refractive index n_{eff} of the grating elements is modulated, thereby altering their diffraction efficiency in real time.

The coupling efficiency η follows:

$$η ∝ Sin {c}^{2} ( \frac{π ( {n}_{eff} - {n}_{bg} ) h}{λ} )$$

where n_{bg} is the background index and h is the grating height. Small changes in n_{eff} from Δn≈0.001 up to 0.3 allow the device to switch between nearly transparent and highly diffractive states within nanoseconds.

### Advantages Over Conventional Couplers:

Ultrafast modulation: Sub-nanosecond refractive index change via pore refilling enables dynamic beam injection synchronized with foveated rendering.

Compact integration: Grating depth <1 μm and micron-scale active lengths fit seamlessly into thin AR/VR waveguide stacks.

Broad spectral operation: III-nitrides support operation from UV (near-eye violet) to NIR (eye-safe infrared), allowing multi-wavelength AR displays.

Low power operation: High overlap between optical mode and modulation region reduces drive voltage below 1 V.

No moving parts: Increases reliability and reduces mechanical complexity compared to MEMS scanners.

### Example Performance Case:

At λ=532 nm, a nanoporous GaN subwavelength grating coupler with Δn tunable from 2.1 to 2.4 achieves real-time brightness modulation from <1% to >90% coupling efficiency. Coupling transition times are <500 ps, enabling gaze-contingent image injection and adaptive brightness control at >2 MHz refresh rates. This makes it possible to project different content into the user's peripheral and foveal vision zones on the fly, dramatically reducing rendering load and improving AR/VR realism.

This example enables AR/VR waveguides with dynamically tunable couplers that outperform liquid crystal and MEMS-based solutions in speed, compactness, and integration capability, paving the way for lightweight, adaptive, and power-efficient wearable displays.

To boost Δn_{eff} above 0.01, the easiest method is to infiltrate the pores with either a liquid crystal or an electro-optics polymer.

In an example, the voids of a nanoporous piezoelectric material scaffold are infiltrated with a nematic liquid crystal (LC) to obtain an electrically reconfigurable composite exhibiting large, reversible index tuning. Suitable LC mixtures (e.g., E7-class) provide high birefringence of about Δn≈0.18-0.19 near 1.06 μm (≈1053-1064 nm), enabling effective-index shifts when the director is reoriented by modest electric fields on the order of a few volts per micron.

For porosity of about 30-50% and sub-wavelength pore sizes (e.g., ≤100 nm at ˜1 μm operating wavelength), practical devices routinely achieve composite index changes of about Δn_{eff}≈0.01-0.03, with several×10⁻² attainable given high fill fraction and well-controlled alignment.

Low-voltage operation is facilitated by electrode geometries that maximize field overlap with the filled pores, such as interdigitated electrodes with ˜1 μm gaps or vertical nanocapacitor stacks across ˜200-500 nm films, which generally permit drive amplitudes in the ˜0.1-3 V range while keeping capacitance and power consumption low.

Surface treatments may establish planar, homeotropic, or tilted anchoring for uniform director control, and barrier coatings or encapsulation can be used to preserve LC integrity over time.

In other example, the porous scaffold is infiltrated with a poled electro-optic (EO) polymer that exhibits a large Pockels coefficient (e.g., r33≈300-1000 μm/V in device form), providing fast, field-driven index tuning. When driven with electric fields on the order of a few volts per micron across a 200-500 nm porous film, the composite device delivers effective refractive-index changes of a few×10⁻² while supporting nanosecond- to picosecond-class response; practical bandwidth is set by the electrical RC of the electrode geometry.

To reach multi-GHz operation at low drive, the active area may be segmented into small pixels (e.g., ˜50-200 μm laterally) to keep capacitance in the sub-pF range and paired with 50Ω traveling-wave or vertical nanocapacitor electrodes.

Low operating voltage is maintained by maximizing field overlap with the filled pores, and long-term stability is achieved by poling above the polymer glass-transition temperature, locking in orientation (e.g., via crosslinking), and sealing with barrier layers to limit oxygen and moisture ingress. This EO-polymer approach offers large Δn_{eff} with substantially higher speed than LC fills, making it well suited for high-frequency photonic phase shifters, cavity tuning, and RF-photonics modulators.

### REFERENCES

[1] Ying Wang, HongMing Fei, Han Lin, Jie Bai, MingDa Zhang, Xin Liu, BinZhao Cao, Yuan Tian, and LianTuan Xiao, “Ultra-compact electro-optic phase modulator based on a lithium niobate topological slow light waveguide,” Opt. Express 32, 3980-3988 (2024)
[2] N. Reingand et al., “Novel design for the broadband linearized optical intensity modulator,” IEEE Military Communications Conference, 2003. MILCOM 2003., Boston, MA, USA, 2003, pp. 1208-1212 Vol. 2, doi: 10.1109/MILCOM.2003.1290371.
[3] Qiu, Xiaoming, Xiaoke Ruan, Yanping Li, and Fan Zhang. “Indium tin oxide based dual-polarization electro-optic intensity modulator on a single silicon waveguide.” Journal of Lightwave Technology 36, no. 13 (2018): 2563-2571.
[4] Lin, Sam, Yixin Chen, and Zi Jing Wong. “High-performance optical beam steering with nanophotonics.” Nanophotonics 11, no. 11 (2022): 2617-2638.
[5] Guo, Huiyong, Amita Gnanapandithan, Yi Liu, Ciming Zhou, Zhou Zheng, Yiwen On, Xiong Zeng, and Li Qian. “Single-arm frequency-shifted interferometry using a bidirectional electro-optic modulator.” Journal of Lightwave Technology 37, no. 4 (2019): 1310-1316.
[6] Ordouie, Ehsan, Tianwei Jiang, Tingyi Zhou, Farzaneh A. Juneghani, Mahdi Eshaghi, Milad G. Vazimali, Sasan Fathpour, and Bahram Jalali. “Differential phase-diversity electrooptic modulator for cancellation of fiber dispersion and laser noise.” Nature communications 14, no. 1 (2023): 6065.
[7] Popovich, Milan M., Jonathan D. Waldern, and John J. Storey. “Holographic projection system.” U.S. Pat. No. 6,211,976, issued Apr. 3, 2001.
[8] Sinatkas, Georgios, Thomas Christopoulos, Odysseas Tsilipakos, and Emmanouil E. Kriezis. “Electro-optic modulation in integrated photonics.” Journal of Applied Physics 130, no. 1 (2021).
[9] Kakio, S. “Acousto-optic modulator driven by surface acoustic waves.” Acta Physica Polonica A 127, no. 1 (2015): 15-19.
[10] Butt, Muhammad A. 2025. “Emerging Trends in Thermo-Optic and Electro-Optic Materials for Tunable Photonic Devices” Materials 18, no. 12: 2782. https://doi.org/10.3390/ma18122782
[11] Liu, J., Beals, M., Pomerene, A. et al. Waveguide-integrated, ultralow-energy GeSi electro-absorption modulators. Nature Photon 2, 433-437 (2008). https://doi.org/10.1038/nphoton.2008.99
[12] Yang, Yiqian, Andrew Forbes, and Liangcai Cao. “A review of liquid crystal spatial light modulators: devices and applications.” Opto-Electronic Science 2, no. 8 (2023): 230026-1.
[13] Han, Zheyi, Shane Colburn, Arka Majumdar, and Karl F. Bohringer. “MEMS-actuated metasurface Alvarez lens.” Microsystems & nanoengineering 6, no. 1 (2020): 79.
[14] Chauhan, Diksha, Zen Sbeah, Ram Prakash Dwivedi, Jean-Michel Nunzi, and Mohindra Singh Thakur. “An investigation and analysis of plasmonic modulators: A review.” Journal of Optical Communications 45, no. 3 (2024): 483-511.

1. A system comprising:
a refractive index modulation (RIM) device comprising a nanoporous piezoelectric material having a plurality of voids;
an energy source generating an external stimulus applied to the nanoporous piezoelectric material to change an effective refractive index (Δn_{eff}) of the nanoporous piezoelectric-material; and
an optical system including the RIM device such that the RIM device is integrated in the optical system.

2. The system of claim 1, wherein the RIM device alters at least one of a phase, an amplitude, a polarization, or a frequency of a light directly or indirectly.

3. The system of claim 1, wherein the nanoporous piezoelectric material is selected from a single-crystalline, a polycrystalline, an amorphous or a composite piezoelectric film.

4. The system of claim 1, wherein the external stimulus is selected from an electric field, an acoustic wave, an optical signal, a thermal signal, or any combination thereof.

5. The system of claim 1, wherein the nanoporous piezoelectric material comprises a plurality of voids, the voids being of an arbitrary shape or a geometry.

6. The system of claim 1, wherein the RIM device is integrated between a first dielectric Bragg reflector (DBR) mirror and a second DBR mirror to form a resonant cavity switching (RCS) device.

7. The system of claim 6, wherein the RCS device is characterized by a cavity finesse exceeding 1000 and a switching speed below 1 nanosecond, and is further configured as at least one of
a wavelength filter or wavelength selector in a wavelength-division multiplexing (WDM) optical network or a single-photon routing element in a quantum communication network.

8. The system of claim 1, wherein the RIM device is configured as an electro-optic phase modulator integrated into a Mach-Zehnder interferometer.

9. The system of claim 1, wherein the RIM device is configured as a high-speed birefringence modulator for a polarization control in a coherent optical system.

10. The system of claim 1, wherein the RIM device is configured as a dynamic optical phase shifter for an adaptive optics, an interferometry, or a laser cavity tuning.

11. The system of claim 1, wherein the RIM device is configured as a frequency shifter by generating a traveling refractive index grating using a surface acoustic wave.

12. The system of claim 1, wherein the RIM device is configured as a pulse picker for selecting a plurality of optical pulses from a mode-locked laser.

13. The system of claim 1, wherein the RIM device is configured as a tunable lens or a beam steering element by spatially varying a refractive index across an aperture.

14. The system of claim 1, wherein the RIM device is configured as a tunable optical filter in a ring resonator or a Bragg grating.

15. The system of claim 1, wherein Δn_{eff} is tunable in a range between 0.001 and 0.3 to enable a fine and coarse spectral tuning.

16. The system of claim 1, wherein the RIM device is fabricated on a substrate selected from a glass, a sapphire, a SiC, a semiconductor, a polymer, or a ceramic material.

17. The system of claim 1, wherein the RIM device is configured as a photonic crystal with a dynamically tunable bandgap.

18. The system of claim 1, wherein the RIM device is configured as a segmented dispersion controller for an ultrafast chirp and a group delay modulation.

19. The system of claim 1, wherein the RIM device is integrated into a hyperspectral imaging system as a rapidly tunable spectral filter.

20. The system of claim 1, wherein the RIM device is configured as a quantum photonic gate with a sub-nanosecond phase control for a single photon.

21. The system of claim 1, wherein the RIM device is configured as a dynamic optical delay line for a quantum memory synchronization.

22. The system of claim 1, wherein the RIM device is configured for a cross-phase modulation between an optical field in an all-optical logic gate.

23. The system of claim 1, wherein the RIM device is fabricated as an addressable pixel array for a dynamic holographic projection.

24. The system of claim 1, wherein the RIM device is patterned as a tunable grating coupler for an AR/VR waveguide image injection.

25. The system of claim 1, wherein the plurality of voids in RIM layer are at least partially filled with an infiltration medium to enhance effective index tunability, the infiltration medium comprising a liquid crystal, a polymer (including an electro-optic polymer), or any combination thereof.

26. A method of modulating a light, comprising:
applying an energy stimulus to a refractive index modulation (RIM) device comprising a nanoporous piezoelectric material having a plurality of voids to change a refractive index of the nanoporous piezoelectric material; and
modulating, using the RIM device, at least one of phase, amplitude, polarization, or frequency of a light directly or indirectly incident on one or more surfaces of the RIM device.

27. The method of claim 26, wherein the modulation is synchronized with one or more optical pulses for a time-gated switching.

28. A photonic system comprising:
a common substrate comprising a first side and a second side opposing the first side; and
at least one refractive index modulation (RIM) device comprising a nanoporous piezo material comprising a plurality of voices integrated with a laser, a detector, and a control electronic on the common substrate.

29. The system of claim 28, wherein the RIM device functions as a tunable cavity mirror to enable a sub-nanosecond wavelength hopping in a multi-wavelength laser source.

30. The system of claim 28, wherein the RIM device is arranged in an array for a beam steering or a phased array LiDAR.

31. The system of claim 28, wherein the RIM device is configured to perform a multi-channel optical routing in a reconfigurable optical add-drop multiplexer (ROADM).

32. The system of claim 28, wherein the RIM device is operable in a wavelength range between 300 nm and 3000 nm.

33. The system of claim 28, wherein the nanoporous piezoelectric material retains a crystal symmetry, thereby preserving an intrinsic electro-optic and piezoelectric coefficient of the nanoporous piezoelectric material.

34. A method of forming a plurality of voids in a piezoelectric material, comprising:
depositing a polycrystalline or amorphous piezoelectric layer on a surface region of a substrate member;
forming the plurality of voids in the piezoelectric layer by subjecting the polycrystalline or amorphous piezoelectric layer to a thermal annealing;
forming a capping layer overlying a surface of the polycrystalline or amorphous piezoelectric material to preserve a surface smoothness of the surface of the polycrystalline or amorphous piezoelectric material.

35. The method of claim 34, wherein the capping layer comprises an oxide material selected from at least one of a SiO₂, a Ga₂O₃, a TiO₂ or an oxide of other metal materials.
